(19) United States
(12) Patent Application Publication
(10) Pub. No.: US 2025/0026867 A1
(43) Pub. Date: Jan. 23, 2025

(54) PROCESS FOR PREPARING AN AQUEOUS POLYMER DISPERSION

(71) Applicant: BASF SE, Ludwigshafen am Rhein (DE)

(72) Inventors: Martin Robert SCHEUBLE, Ludwigshafen am Rhein (DE); Immanuel WILLERICH, Ludwigshafen am Rhein (DE); Joerg-Alexander DIMMER, Ludwigshafen am Rhein (DE); Jochen GATTERMAYER, Ludwigshafen am Rhein (DE); Felix LAUTERBACH, Ludwigshafen am Rhein (DE)

(21) Appl. No.: 18/711,652

(22) PCT Filed: Nov. 22, 2022
(86) PCT No.: PCT/EP2022/082799

§ 371 Date: May 20, 2024

(30) Foreign Application Priority Data
Nov. 23, 2021 (EP) 21209970.9

(51) Int. Cl. C08F 2/26; C08F 265/06; C09D 7/41; C09D 151/00

(52) U.S. Cl. CPC C08F 2/26; C08F 265/06; C09D 7/41; C09D 151/003

(57) ABSTRACT

The present invention relates to a process for preparing an aqueous polymer dispersion comprising using a first aqueous mixture M(1) and a second aqueous mixture M(2), an aqueous polymer dispersion obtainable or obtained by said process and a use of said dispersion as a binder, preferably for decorative coatings. Further, the present invention relates to a coating, such as paint and paint formulation comprising said dispersion.

The present invention relates to a process for preparing an aqueous polymer dispersion, an aqueous polymer dispersion and a use of said dispersion as a binder, preferably for decorative coatings. Further, the present invention relates to a coating, such as paint and paint formulation comprising said dispersion.

Aqueous polymer dispersions are frequently used as binders in polymer bound coating compositions. High quality coating compositions are often formulated at pigment volume concentrations (PVC) below the critical pigment volume concentration. Beside the classical important properties like wet scrub resistance and opacity, the adhesion of these binder-rich formulations on various substrates is a critical property especially if the coating is exposed to humidity, is in direct water contact due to surface wetting or during the overcoating process of an underlying first coating layer.

Classically, the wet adhesion is enhanced by introduction of wet adhesion promoting functional monomers like ureido methacrylate. EP 0710680 A2 describes the usage of N-containing adhesion promoting monomers and the beneficial coating performance like enhanced wet adhesion which can be achieved. However, the polymerization of monomer mixtures containing N-containing adhesion promoting monomers like those claimed in EP 0710680 A2 results in the reduction of the wet scrub resistance of the coating and in an increased water sensitivity.

Formulations nowadays strive for as low as possible VOC (Volatile organic compounds) or SVOC (Semi volatile organic compounds). Thus, the polymers used in these formulations have to ensure film forming at low temperatures which can be achieved by the reduction of the glass transition temperature (Tg) of the used binder. Often, this is accompanied with pronounced tackiness of the coating film.

EP 2840092 A1 discloses an aqueous dispersion of polymer particles comprising two polymeric domains comprising ureido monomers, a first polymeric domain and a second polymeric domain wherein the first polymeric domain is film forming at room temperature and the second polymeric domain has a Fox glass transition temperature (Tg) of not less than 35° C.

Therefore, there is a need to provide an improved process for preparing an aqueous polymer dispersion which exhibits great wet adhesion and outstanding wet scrub resistance while the tackiness of the coating film is kept at a minimum level when used as binders in decorative coatings. It was surprisingly found that the process for preparing an aqueous polymer dispersion according to the present invention permits to achieve such objectives.

Therefore, the present invention relates to a process for preparing an aqueous polymer dispersion D(P), the process comprising
(i) providing a first aqueous mixture M(1) comprising water and ethylenically unsaturated monomers, wherein at least x weight-% of said ethylenically unsaturated monomers consist of one or more monomers according to formula (I)

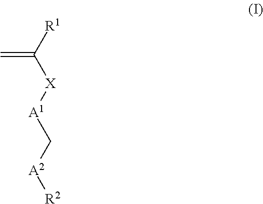

wherein R¹ is H or CH₃, X is CO or CH₂, A¹ is O or NH, A² is selected from the group consisting of CH₂, C(CH₃)₂ and CH(OH) and R² is selected from the group consisting of an ester group, an amido group, a urea group, an alkylamine group, a carbonyl group, an alkyl group and an alkoxy group, wherein from 95 to 100 weight-% of M(1) consist of water and said ethylenically unsaturated monomers;
(ii) providing a second aqueous mixture M(2) comprising water and at least two different ethylenically unsaturated monomers, wherein from 55 to 98 weight-% of said unsaturated monomers consist of one or more of vinyl aromatic monomers, C₁-C₂₀-alkyl esters of methacrylic acid and C₁-C₂₀-alkyl esters of acrylic acid, and wherein y weight-% of said ethylenically unsaturated monomers consist of the one or more monomers according to formula (I) with 0≤y<x, and wherein from 95 to 100 weight-% of M(2) consist of water and said at least two different ethylenically unsaturated monomers;
(iii) introducing M(2) into a polymerization vessel and subjecting the ethylenically unsaturated monomers comprised in M(2) to co-polymerization for a first polymerization period Δt(1), obtaining an intermediate mixture M(i);
(iv) introducing, after Δt(1), M(1) into the polymerization vessel comprising M(i), admixing M(1) and M(i) obtaining a polymerization mixture M(P), and subjecting the ethylenically unsaturated monomers to co-polymerization, obtaining, after a second polymerization period Δt(2), the aqueous polymer dispersion D(P), wherein at least 95 weight-% of the polymers comprised in D(P) after Δt(2) are based on the ethylenically unsaturated monomers comprised in M(1) and M(2).

Preferably Tg(2)>Tg(1), Tg(2) being the theoretical glass transition temperature (Tg) of the polymer which would be obtained from polymerization of the monomers of the mixture M(2) and Tg(1) being the theoretical glass transition temperature (Tg) of the polymer which would be obtained from polymerization of the monomers of the mixture M(1), wherein said theoretical glass transition temperatures Tg(1) and Tg(2) are determined according to the Fox equation.

In the context of the present invention, it is preferred that Tg(2)−Tg(1)>30° C., more preferably Tg(2)−Tg(1)>60° C., more preferably Tg(2)−Tg(1)>80° C., Tg(2) being the theoretical glass transition temperature (Tg) of the polymer which would be obtained from polymerization of the monomers of the mixture M(2) and Tg(1) being the theoretical glass transition temperature (Tg) of the polymer which would be obtained from polymerization of the monomers of the mixture M(1), wherein said theoretical glass transition temperatures Tg(1) and Tg(2) are determined according to the Fox equation.

Preferably Tg(2)>30° C., more preferably Tg(2)>60° C., more preferably Tg(2)>75° C., more preferably 75° C.<Tg(2)<110° C., Tg(2) being the theoretical glass transition temperature (Tg) of the polymer which would be obtained from polymerization of the monomers of the mixture M(2).

Preferably Tg(1)<−5° C., more preferably Tg(1)<−15° C., more preferably Tg(1)<−20° C., more preferably −40° C.<Tg(1)<−20° C., Tg(1) being the theoretical glass transition temperature (Tg) of the polymer which would be obtained from polymerization of the monomers of the mixture M(1).

### Aqueous Mixture M(1)

### Monomers of Formula (I)

In formula (I), it is preferred that R² is selected from the group consisting of an ester group, an amido group, a urea group and an alkylamine group, the alkylamine more preferably being a dialkylamine.

Preferably, in formula (I), R² is an ester group, R¹ is CH₃, X is CO, A¹ is O and A² is CH₂, wherein more preferably the ester group R² is —OCORₐ, wherein more preferably Rₐ is —CH₂COCH₃.

More preferably the monomer of formula (I), comprised in the first aqueous mixture M(1), is acetoacetoxyethyl methacrylate.

Preferably, in formula (I), R² is a urea group, wherein more preferably the urea group is —NR C₁(CO)NHR_{c2}, wherein each of R_{c1} and R_{c2} is independently H or a C₁-C₂-alkyl group. More preferably R_{c1} is a C₁-C₂-alkyl group, more preferably a C₁-alkyl group, and R_{c2} is a C₁-C₂-alkyl group, more preferably a C₁-alkyl group, wherein R_{c1} and R_{c2} are linked. More preferably, in formula (I), R² is a urea group, R¹ is CH₃, X is CO, A¹ is O and A² is CH₂; wherein more preferably the monomer of formula (I), comprised in the first aqueous mixture M(1), is ureido methacrylate.

In the context of the present invention, it is preferred that the monomers according to formula (I), comprised in the first aqueous mixture M(1), are at least two different monomers of formula (I). More preferably the at least two monomers are
a monomer, wherein R¹ is CH₃, X is CO, A¹ is O, A² is CH₂ and R² is an ester group, and
a monomer, wherein R¹ is CH₃, X is CO, A¹ is O, A² is CH₂ and R² is a urea group.

More preferably the monomers of formula (I) are acetoacetoxyethyl methacrylate and ureido methacrylate. Alternatively, it is preferred that the monomers according to formula (I), comprised in the first aqueous mixture M(1), are the same monomers, wherein R¹ is CH₃, X is CO, A¹ is O, A² is CH₂ and R² is an ester group or wherein R¹ is CH₃, R¹ is CH₃, X is CO, A¹ is O, A² is CH₂ and R² is a urea group. More preferably the monomers according to formula (I) are ureido methacrylate. As an alternative, the monomers according to formula (I) are preferably acetoacetoxyethyl methacrylate.

Preferably the monomers according to formula (I), comprised in the first aqueous mixture M(1), are the same monomers, wherein R¹ is CH₃, X is CO, A¹ is O, A² is C(CH₃)₂ and R² is an amido group, preferably —NHCOCH₂R, wherein R more preferably is an acetyl group. Alternatively the monomers according to formula (I), comprised in the first aqueous mixture M(1), preferably are at least two different monomers of formula (I), wherein the at least two monomers are
a monomer, wherein R¹ is CH₃, X is CO, A¹ is O, A² is CH₂ and R² is an ester group or a urea group and
a monomer, wherein R¹ is CH₃, X is CO, A¹ is O, A² is C(CH₃)₂ and R² is an amido group, preferably —NHCOCH₂R, wherein R more preferably is an acetyl group. Said monomer has preferably the following formula:

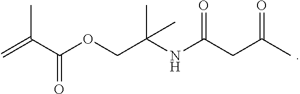 [SMILES: C=C(C)C(=O)OCC(C)(C)NC(=O)CC(C)=O]

Preferably the monomers according to formula (I), comprised in the first aqueous mixture M(1), are the same monomers, wherein R¹ is H, X is CH₂, A¹ is O, A² is CH(OH) and R² is an alkylamine group, more preferably —CH₂—NH—(CH₂)₂—R, wherein R more preferably is a urea group, the urea group being more preferably as defined in the foregoing. Alternatively, it is preferred that the monomers according to formula (I), comprised in the first aqueous mixture M(1), are at least two different monomers of formula (I), wherein the at least two monomers are a monomer, wherein R¹ is CH₃, X is CO, A¹ is O, A² is CH₂ and R² is an ester group or a urea group and a monomer, wherein R¹ is H, X is CH₂, A¹ is O, A² is CH(OH) and R² is a dialkylamine group, preferably —CH₂—NH—(CH₂)₂—R, wherein R more preferably is a urea group, the urea group being more preferably as defined in the foregoing. Said monomer preferably has the following formula:

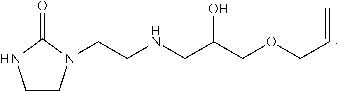 [SMILES: C=CCOCC(O)CNCCN1CCNC1=O]

In the context of the present invention, it is preferred that x is in the range of from 0.25 to 15, more preferably in the range of from 0.5 to 10, more preferably in the range of from 2 to 7, more preferably in the range of from 2 to 3 or more preferably in the range of from 4 to 6.

### Acidic Monomers

Preferably the ethylenically unsaturated monomers comprised in the first aqueous mixture M(1) further comprises monomers which exhibit a Bronsted acidic group, wherein the monomers which exhibit a Bronsted acidic group are more preferably selected from the group consisting of monoethylenically unsaturated monocarboxylic acids having 3 to 6 carbon atoms, monoethylenically unsaturated dicarboxylic acids having 4 to 6 carbon atoms and a mixture thereof, more preferably monoethylenically unsaturated monocarboxylic acids having 3 to 6 carbon atoms.

Preferably from 0.5 to 5 weight-%, more preferably from 1 to 5 weight-%, more preferably from 2 to 4 weight-%, of the ethylenically unsaturated monomers comprised in the first aqueous mixture M(1) consist of the monomers which exhibit a Bronsted acidic group.

Preferably the monoethylenically unsaturated monocarboxylic acid having 3 to 6 carbon atoms is one or more of methacrylic acid, acrylic acid, crotonic acid, 2-ethylpropenoic acid, 2-propylpropenoic acid, 2-acryloxyacetic acid and 2-methacycloxyacetic acid, preferably one or more of methacrylic acid and acrylic acid, more preferably methacrylic acid or acrylic acid.

Preferably, in the first aqueous mixture M(1), the ratio of the masses of the monomers which exhibit a Bronsted acidic group, m₁(a), to the one or more monomers of formula (I), m₁(monomers), m₁(a):m₁(monomers), is in the range of from 0.25:1 to 3:1, more preferably in the range of from 0.3:1 to 2:1, more preferably in the range of from 0.4:1 to 1.25:1, more preferably in the range of from 0.4:1 to 0.75:1 or more preferably in the range of from 1:1 to 1.25:1.

### Alkyl-Ester of (Meth)Acrylic Acid Monomers

Preferably the ethylenically unsaturated monomers comprised in the first aqueous mixture M(1) further comprises one or more of C₁-C₂₀-alkyl esters of acrylic acid and C₁-C₂₀-alkylesters of methacrylic acid, preferably one or more of C₂-C₁₀ alkyl esters of acrylic acid and C₁-C₁₀ alkyl esters of methacrylic acid, more preferably comprises C₂-C₁₀ alkyl esters of acrylic acid and C₁-C₁₀ alkyl esters of methacrylic acid.

As to the C₁-C₂₀-alkyl ester of acrylic acid, it is preferred that it is selected from the group consisting of methyl acrylate, ethyl acrylate, n-propyl acrylate, isopropyl-acrylate, n-butyl acrylate, 2-butyl acrylate, isobutyl acrylate, n-pentyl acrylate, isoamyl acrylate, n-hexyl acrylate, n-octyl acrylate, 2-octyl acrylate, 2-ethylhexylacrylate, n-decyl acrylate, 2-propylheptyl acrylate, lauryl acrylate, C₁₂-C₁₄-alkyl acrylate, stearyl acrylate, isobornyl acrylate, and a mixture of two or more thereof.

As to the C₂-C₁₀ alkyl ester of acrylic acid, it is preferred that it is selected from the group consisting of ethyl acrylate, 2-ethylhexyl acrylate, n-butyl acrylate, iso-butyl acrylate, isoamyl acrylate, n-hexyl acrylate, n-octyl acrylate, 2-octyl acrylate, 2-propylheptyl acrylate, acrylate and a mixture of two or more thereof, more preferably selected from the group consisting of 2-ethylhexyl acrylate, 2-octyl acrylate, iso-butyl acrylate, ethyl acrylate, n-butyl acrylate, isoamyl acrylate and a mixture of two or more thereof, more preferably selected from the group consisting of 2-ethylhexyl acrylate, 2-octyl acrylate, iso-butyl acrylate, ethyl acrylate and a mixture thereof, more preferably is 2-ethylhexyl acrylate.

Preferably from 40 to 90 weight-%, more preferably from 55 to 85 weight-%, more preferably from 65 to 80 weight-%, of the ethylenically unsaturated monomers comprised in the first aqueous mixture M(1) consist of C₁-C₂₀-alkyl esters of acrylic acid, more preferably of C₂-C₁₀ alkyl ester of acrylic acid monomers.

As to the C₁-C₂₀-alkyl esters of methacrylic acid, it is preferred that it is selected from the group consisting of methyl methacrylate, ethyl methacrylate, propyl methacrylate, n-butyl methacrylate, isobutyl methacrylate, cyclohexyl methacrylate, benzyl methacrylate, isobornyl methacrylate, n-pentyl methacrylate, n-hexyl methacrylate, n-octyl methacrylate, 2-ethylhexyl methacrylate, n-decyl methacrylate, 2-propylheptyl methacrylate, lauryl methacrylate, C₁₂-C₁₄-alkyl methacrylate, stearyl methacrylate and a mixture of two or more thereof.

As to the C₁-C₁₀ alkyl ester of methacrylic acid, it is preferred that it is selected from the group consisting of methyl methacrylate, ethyl methacrylate, propyl methacrylate, n-butyl methacrylate, isobutyl methacrylate, cyclohexyl methacrylate, benzyl methacrylate, isobornyl methacrylate, and a mixture of two or more thereof, more preferably selected from the group consisting of methyl methacrylate, ethyl methacrylate and isobornyl methacrylate, more preferably methyl methacrylate.

Preferably from 9.25 to 40 weight-%, more preferably from 13.5 to 30 weight-%, more preferably from 16 to 24 weight-% of the ethylenically unsaturated monomers comprised in the first aqueous mixture M(1) consist of C₁-C₂₀ alkyl esters of methacrylic acid monomers, more preferably of C₁-C₁₀ alkyl esters of methacrylic acid monomers.

### Surfactants

Preferably the first aqueous mixture M(1) further comprises one or more surfactants, wherein the surfactants are selected from the group consisting of an anionic surfactant, a non-ionic surfactant and a mixture thereof.

Preferably from 0 to 5 weight-%, more preferably from 0.1 to 3 weight-%, more preferably from 0.5 to 2.8 weight-%, of the first aqueous mixture M(1) consist of the one or more surfactants.

As to the anionic surfactant, it is preferred that it comprises at least one anionic group, which is more preferably selected from the group consisting of phosphate, phosphonate, sulfate and sulfonate groups.

Preferably, when the anionic surfactant comprises at least one anionic group, the anionic surfactant more preferably is in the form of its alkali metal salt, more preferably its sodium salt or ammonium salt.

Preferably the anionic surfactant is an anionic emulsifier comprising at least one a sulfate group, a sulfonate group, a phosphate group or a phosphonate group. More preferably the surfactants comprised in the first aqueous mixture M(1) comprises an anionic surfactant comprising a phosphate group or phosphonate group and an anionic surfactant comprising a sulfate group or sulfonate group.

Preferably the anionic surfactant is an anionic emulsifier comprising a sulfate group or a sulfonate group;
said anionic surfactant being more preferably one or more of a salt of alkyl sulfates, more preferably C₈-C₂₂-alkyl sulfates, a salt of sulfuric monoesters of ethoxylated alkanols, more preferably sulfuric monoesters of ethoxylated C₈-C₂₂-alkanols, more preferably having an ethoxylation level (EO level) in the range of from 2 to 40, a salt of alkylsulfonic acids, more preferably C₈-C₂₂-alkylsulfonic acids, a salt of dialkyl esters, more preferably di-C₄-C₁₈-alkyl esters of sulfosuccinic acid, a salt of alkylbenzenesulfonic acids, more preferably C₄-C₂₂-alkylbenzenesulfonic acids, and a salt of mono- or disulfonated alkyl-substituted diphenyl ethers, more preferably bis(phenylsulfonic acid) ethers bearing a C₄-C₂₄-alkyl group on one or both aromatic rings. Other examples of emulsifiers are disclosed in U.S. Pat. No. 4,269,749 and are commercially available said emulsifiers can also be preferably used in the first aqueous mixture M(1). A further emulsifier which can preferably be used in the first aqueous mixture M(1) is Dowfax® 2A1 (Dow Chemical Company).

In the context of the present invention, it is preferred that the salts are alkali metal salts or ammonium salts.

Preferably said anionic surfactant is one or more of a salt of alkyl sulfates, more preferably C₈-C₂₂-alkyl sulfates, a salt, more preferably an alkali metal salt, of sulfuric monoesters of ethoxylated alkanols, more preferably sulfuric monoesters of ethoxylated C₈-C₂₂-alkanols, more preferably having an ethoxylation level (EO level) in the range of from 2 to 40, a salt, more preferably an alkali metal salt, of mono- or disulfonated alkyl-substituted diphenyl ethers, more preferably bis(phenylsulfonic acid) ethers bearing a C₄-C₂₄-alkyl group on one or both aromatic rings.

Preferably the anionic surfactant is an anionic surfactant comprising a phosphate or phosphonate group;
said anionic surfactant being more preferably one or more of a salt of mono- or dialkyl phosphates, more preferably C₈-C₂₂-alkyl phosphates, a salt of phosphoric monoesters of C₂-C₃-alkoxylated alkanols, more preferably having an alkoxylation level in the range of from 2 to 40, more preferably in the range of from 3 to 30, a salt of alkylphosphonic acids, more preferably C₈-C₂₂-alkylphosphonic acids and a salt of alkylbenzenephosphonic acids, more preferably C₄-C₂₂-alkylbenzenephosphonic acids;
the salt of phosphoric monoesters of C₂-C₃-alkoxylated alkanols more preferably is a salt of phosphoric monoesters of ethoxylated C₈-C₂₂-alkanols, more preferably having an ethoxylation level (EO level) in the range of from 2 to 40, a salt of phosphoric monoesters of propoxylated C₈-C₂₂-alkanols, more preferably having a propoxylation level (PO level) in the range of from 2 to 40, and a salt of phosphoric monoesters of ethoxylated-co-propoxylated C₈-C₂₂-alkanols, more preferably having an EO level (ethoxylation level) in the range of from 1 to 20 and a PO level of 1 to 20.

Further, the surfactant can preferably be non-ionic surfactant being more preferably a nonionic emulsifier; wherein said nonionic emulsifier is selected from the group consisting of araliphatic and aliphatic nonionic emulsifiers, more preferably ethoxylated mono-, di- and trialkylphenols having more preferably a EO level (ethoxylation level) in the range of from 3 to 50 and an alkyl radical: C₄-C₁₀, ethoxylates of long-chain alcohols having more preferably a EO level in the range of from 3 to 100 and an alkyl radical: C₈-C₃₆, polyethylene oxide/polypropylene oxide homo- and copolymers and a mixture of two or more thereof. When the first aqueous mixture M(1) can further preferably comprises an anionic surfactant and a non-ionic surfactant, the ratio of the weight of the anionic surfactant relative to the weight of the non-ionic surfactant is in the range of from 0.5:1 to 10:1, more preferably in the range of from 1:1 to 5:1.

In the context of the present invention, it is preferred that the first aqueous mixture M(1) comprises at least two surfactants, which are chemically and physically different from one other.

In the context of the present invention, it is preferred that from 95 to 100 weight-%, more preferably from 97 to 99.9 weight-%, more preferably in the range of from 97.2 to 99.5 weight-%, of M(1) consist of water and the ethylenically unsaturated monomers.

Preferably the first aqueous mixture M(1) is an emulsion.

Preferably from 98 to 100 weight-%, more preferably from 99 to 100 weight-%, more preferably from 99.5 to 100 weight-%, more preferably from 99.9 to 100 weight-%, of the first aqueous mixture M(1) consist of water and the ethylenically unsaturated monomers, and more preferably one or more surfactants as defined in the foregoing.

Preferably from 98 to 100 weight-%, more preferably from 99 to 100 weight-%, more preferably from 99.5 to 100 weight-%, more preferably from 99.9 to 100 weight-%, of the ethylenically unsaturated monomers comprised in the first aqueous mixture M(1) consist of the one or more monomers of formula (I), the monomers which exhibit a Bronsted acidic group as defined in the foregoing, the C₁-C₂₀ alkyl esters of acrylic acid as defined in the foregoing, more preferably-C₂-C₁₀ alkyl esters of acrylic acid as defined the foregoing, and the C₁-C₂₀-alkylesters of methacrylic acid as defined in the foregoing, more preferably C₁-C₁₀ alkyl ester of methacrylic acid as defined the foregoing.

Preferably, in the first aqueous mixture M(1), the ratio of the masses of water, m₁(H₂O), to the ethylenically unsaturated monomers, m₁(monomers), is in the range of from 0.1:1 to 0.5:1, more preferably in the range of from 0.2:1 to 0.45:1, more preferably in the range of from 0.25:1 to 0.4:1.

### Second Aqueous Mixture M(2)

Preferably from 65 to 95 weight-%, more preferably from 80 to 95 weight-%, more preferably from 85 to 93 weight-%, of the ethylenically unsaturated monomers comprised in the second aqueous mixture M(2) consist of one or more of vinyl aromatic monomers, C₁-C₂₀-alkyl esters of methacrylic acid, and C₁-C₂₀-alkyl esters of acrylic acid, more preferably one or more of styrene, methyl methacrylate, ethyl acrylate, n-propyl acrylate, isopropyl-acrylate, n-butyl acrylate, 2-butyl acrylate, isobutyl acrylate, t-butyl methacrylate, t-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C12/C14-alkyl acrylate, stearyl acrylate, cyclohexylmethacrylate, isobornyl acrylate, isobornyl methacrylate, 2-methylstyrene, 4-methylstyrene, 2-n-butylstyrene, 4-n-butylstyrene, α-methylstyrene and vinyl acetate.

More preferably from 65 to 95 weight-%, more preferably from 80 to 95 weight-%, more preferably from 85 to 93 weight-%, of the ethylenically unsaturated monomers comprised in the second aqueous mixture M(2) consist of one or more of styrene, methyl methacrylate, ethyl methacrylate, t-butyl methacrylate, t-butyl acrylate, cyclohexylmethacrylate, benzyl methacrylate, isobornyl acrylate, isobornyl methacrylate, and vinyl acetate; preferably one or more of styrene, methyl methacrylate, t-butyl methacrylate, t-butyl acrylate and cyclohexylmethacrylate, more preferably of one or more of styrene and methyl methacrylate, more preferably of styrene or methyl methacrylate, more preferably styrene.

Preferably the ethylenically unsaturated monomers comprised in the second aqueous mixture M(2) comprise styrene and methyl methacrylate; wherein the weight ratio of styrene to methyl methacrylate in the second aqueous mixture M(2) is more preferably in the range of from 0.2:1 to 4:1, more preferably in the range of from 0.3:1 to 3:1. More preferably from 65 to 95 weight-%, more preferably from 80 to 95 weight-%, more preferably from 85 to 93 weight-%, of the ethylenically unsaturated monomers comprised in the second aqueous mixture M(2) consist of styrene and methyl methacrylate.

### Acidic Monomers

Preferably the ethylenically unsaturated monomers comprised in the second aqueous mixture M(2) further comprises monomers which exhibit a Bronsted acidic group comprised in M(2), said monomers are selected from the group consisting of monoethylenically unsaturated monocarboxylic acids having 3 to 6 carbon atoms, monoethylenically unsaturated dicarboxylic acids having 4 to 6 carbon atoms, and mixture of two or more thereof, more preferably monoethylenically unsaturated monocarboxylic acids having 3 to 6 carbon atoms.

Preferably the monoethylenically unsaturated monocarboxylic acids having 3 to 6 carbon atoms are one or more of methacrylic acids, acrylic acids, crotonic acids, 2-ethylpropenoic acids, 2-propylpropenoic acids, 2-acryloxyacetic acids and 2-methacyloxyacetic acids, preferably one or more of methacrylic acids and acrylic acids, more preferably methacrylic acids or acrylic acids.

Preferably from 1.0 to 10 weight-%, more preferably from 1.5 to 5 weight-%, more preferably from 2 to 5 weight-%, of the ethylenically unsaturated monomers comprised in the second aqueous mixture M(2) consist of monomers which exhibit a Bronsted acidic group.

### Other Monomers

Preferably the ethylenically unsaturated monomers comprised in the second aqueous mixture M(2) further comprises C₁-C₂₀-alkyl esters of acrylic acid, wherein the C₁-C₂₀-alkyl ester of acrylic acid is more preferably selected from the group consisting of methyl acrylate, ethyl acrylate, n-propyl acrylate, isopropyl-acrylate, n-butyl acrylate, acrylate, 2-butyl acrylate, isobutyl acrylate, n-pentyl acrylate, iso-amyl acrylate, n-hexyl acrylate, n-octyl acrylate, 2-octyl acrylate, 2-ethylhexylacrylate, n-decyl acrylate, 2-propylheptyl acrylate, lauryl acrylate, C₁₂/C₁₄-alkyl acrylate, stearyl acrylate, isobornyl acrylate, and a mixture of two or more thereof.

More preferably the ethylenically unsaturated monomers comprised in the second aqueous mixture M(2) further comprises C₂-C₁₀ alkyl esters of acrylic acid, wherein the ester of acrylic acid is more preferably selected from the group consisting of n-butyl acrylate, iso-butyl acrylate, iso-amyl acrylate, n-hexyl acrylate, n-octyl acrylate, 2-octyl acrylate, 2-ethylhexyl acrylate, 2-propylheptyl acrylate, isobornyl acrylate, and a mixture of two or more thereof, more preferably selected from the group consisting of n-butyl acrylate, iso-butyl acrylate, iso-amyl acrylate, 2-octyl acrylate, 2-ethylhexyl acrylate and a mixture of two or more thereof, more preferably selected from the group consisting of n-butyl acrylate, 2-ethylhexyl acrylate and a mixture thereof, more preferably is 2-ethylhexyl acrylate.

Preferably from 3.5 to 25 weight-%, more preferably from 3.5 to 15 weight-%, more preferably from 5 to 10 weight-%, of the ethylenically unsaturated monomers comprised in the second aqueous mixture M(2) consist of C₁-C₂₀-alkyl esters of acrylic acid, more preferably C₂-C₁₀ alkyl esters of acrylic acid.

Preferably 0≤y<0.5, more preferably 0≤y<0.2, more preferably 0≤y<0.1. In other words, it is preferred that the second aqueous mixture M(2) be substantially free, more preferably free of, a monomer of formula (I).

Preferably from 95 to 100 weight-%, more preferably from 97 to 99.9 weight-%, more preferably from 97.2 to 99.5 weight-%, of M(2) consist of water and at least two different ethylenically unsaturated monomers.

### Surfactants

Preferably the second aqueous mixture M(2) further comprises one or more surfactants, wherein the surfactants are each selected from the group consisting of an anionic surfactant, a non-ionic surfactant and a mixture thereof.

The anionic surfactant preferably comprises at least one anionic group, which is more preferably selected from the group consisting of phosphate, phosphonate, sulfate and sulfonate groups.

When the anionic surfactant comprises at least one anionic group, the anionic surfactant more preferably is in the form of its alkali metal salt, more preferably its sodium salt or ammonium salt.

Preferably from 0 to 5 weight-%, more preferably from 0.1 to 3 weight-%, more preferably from 0.5 to 2.8 weight-%, of the second aqueous mixture M(2) consist of the one or more surfactants.

Preferably the anionic surfactant comprised in the second aqueous mixture M(2) is an anionic emulsifier comprising at least one a sulfate group, a sulfonate group, a phosphate group or a phosphonate group. More preferably the surfactants comprised in the second aqueous mixture M(2) comprises an anionic surfactant comprising a phosphate group or phosphonate group and an anionic surfactant comprising a sulfate group or sulfonate group.

Preferably the anionic surfactant comprised in the second aqueous mixture M(2) being an anionic emulsifier comprising a sulfate group or a sulfonate group is one or more of a salt of alkyl sulfates, more preferably C₈-C₂₂-alkyl sulfates, a salt of sulfuric monoesters of ethoxylated alkanols, more preferably sulfuric monoesters of ethoxylated C₈-C₂₂-alkanols, more preferably having an ethoxylation level (EO level) in the range of from 2 to 40, a salt of alkylsulfonic acids, more preferably C₈-C₂₂-alkylsulfonic acids, a salt of dialkyl esters, more preferably di-C₄-C₁₈-alkyl esters of sulfosuccinic acid, a salt of alkylbenzenesulfonic acids, more preferably C₄-C₂₂-alkylbenzenesulfonic acids, and a salt of mono- or disulfonated alkyl-substituted diphenyl ethers, more preferably bis(phenylsulfonic acid) ethers bearing a C₄-C₂₄-alkyl group on one or both aromatic rings. Other examples of emulsifiers are disclosed in U.S. Pat. No. 4,269,749 A and are commercially available said emulsifiers can also be preferably used in the first aqueous mixture M(1).

In the context of the present invention, it is preferred that the salts are alkali metal salts or ammonium salts.

More preferably said anionic surfactant is one or more of a salt of alkyl sulfates, more preferably C₈-C₂₂-alkyl sulfates, a salt, more preferably an alkali metal salt, of sulfuric monoesters of ethoxylated alkanols, more preferably sulfuric monoesters of ethoxylated C₈-C₂₂-alkanols, more preferably having an ethoxylation level (EO level) in the range of from 2 to 40, a salt, more preferably an alkali metal salt, of sulfuric monoesters of ethoxylated alkanols, preferably sulfuric monoesters of ethoxylated C₈-C₂₂-alkanols, more preferably having an ethoxylation level (EO level) in the range of from 2 to 40, a salt, preferably an alkali metal salt, of mono- or disulfonated alkyl-substituted diphenyl ethers, more preferably bis(phenylsulfonic acid) ethers bearing a C₄-C₂₄-alkyl group on one or both aromatic rings.

Preferably the anionic surfactant comprised in the second aqueous mixture M(2) being an anionic surfactant comprising a phosphate or phosphonate group is one or more of a salt of mono- or dialkyl phosphates, more preferably C₈-C₂₂-alkyl phosphates, a salt of phosphoric monoesters of C₂-C₃-alkoxylated alkanols, more preferably having an alkoxylation level in the range of from 2 to 40, more preferably in the range of from 3 to 30, a salt of alkylphosphonic acids, more preferably C₈-C₂₂-alkylphosphonic acids and a salt of alkylbenzenephosphonic acids, more preferably C₄-C₂₂-alkylbenzenephosphonic acids;
the salt of phosphoric monoesters of C₂-C₃-alkoxylated alkanols more preferably is a salt of phosphoric monoesters of ethoxylated C₈-C₂₂-alkanols, more preferably having an ethoxylation level (EO level) in the range of from 2 to 40, a salt of phosphoric monoesters of propoxylated C₈-C₂₂-alkanols, more preferably having a propoxylation level (PO level) in the range of from 2 to 40, and a salt of phosphoric monoesters of ethoxylated-co-propoxylated C₈-C₂₂-alkanols, more preferably having an EO level in the range of from 1 to 20 and a PO level of 1 to 20.

Further, the surfactant can preferably be non-ionic surfactant being more preferably a nonionic emulsifier; wherein said nonionic emulsifier is selected from the group consisting of araliphatic and aliphatic nonionic emulsifiers, more preferably ethoxylated mono-, di- and trialkylphenols having more preferably a EO level (ethoxylation level) in the range of from 3 to 50 and an alkyl radical: C₄-C₁₀, ethoxylates of long-chain alcohols having more preferably a EO level in the range of from 3 to 100 and an alkyl radical: C₈-C₃₆, polyethylene oxide/polypropylene oxide homo- and copolymers and a mixture of two or more thereof. When the second aqueous mixture M(1) can further preferably comprises an anionic surfactant and a non-ionic surfactant, the ratio of the weight of the anionic surfactant relative to the weight of the non-ionic surfactant is in the range of from 0.5:1 to 10:1, more preferably in the range of from 1:1 to 5:1.

In the context of the present invention, it is preferred that the second aqueous mixture M(2) comprises at least two surfactants, which are chemically and physically different from one other.

Preferably the second aqueous mixture M(2) comprises an anionic surfactant comprising a phosphate group and an anionic surfactant comprising a sulfate group.

Preferably the second aqueous mixture M(2) is an emulsion.

Preferably from 98 to 100 weight-%, more preferably from 99 to 100 weight-%, more preferably from 99.5 to 100 weight-%, more preferably from 99.9 to 100 weight-%, of the second aqueous mixture M(2) consist of water and the ethylenically unsaturated monomers, and more preferably one or more surfactants as defined in the foregoing.

Preferably from 98 to 100 weight-%, more preferably from 99 to 100 weight-%, more preferably from 99.5 to 100 weight-%, more preferably from 99.9 to 100 weight-%, of the ethylenically unsaturated monomers comprised in the second aqueous mixture M(2) consist of the one or more of styrene, methyl methacrylate, t-butyl methacrylate, t-butyl acrylate, cyclohexylmethacrylate and vinyl acetate, the monomers which exhibit a Bronsted acidic group as defined in the foregoing, and C₁-C₂₀, more preferably C₂-C₁₀, alkyl esters of acrylic acid as defined in the foregoing.

Preferably, in the second aqueous mixture M(2), the ratio of the masses of water, m₂(H₂O), to the ethylenically unsaturated monomers, m₂(monomers), is in the range of from 0.1:1 to 0.5:1, more preferably in the range of from 0.2:1 to 0.45:1, more preferably in the range of from 0.25:1 to 0.4:1.

Preferably the ratio of the masses of the ethylenically unsaturated monomers comprised in M(1), m₁(monomers), to the ethylenically unsaturated monomers comprised in M(2), m₂(monomers), is in the range of from 0.75:1 to 8:1, more preferably in the range of from 1:1 to 6:1, more preferably in the range of from 1.25:1 to 4:1, more preferably in the range of from 1.5:1 to 3:1.

Preferably the ratio of the masses of M(1), m(M(1)), and M(2), m(M(2)), m(M(1)):m(M(2)), is in the range of from 0.75:1 to 8:1, more preferably in the range of from 1:1 to 6:1, more preferably in the range of from 1.25:1 to 4:1, more preferably in the range of from 1.5:1 to 3:1.

Steps (iii) and (iv)

Preferably the polymerization vessel wherein M(2) is introduced according to (iii) comprises water and one or more of an initiator and seed latex, more preferably water, seed latex, more preferably polystyrene, and an initiator.

It is preferred that the process comprises introducing M(2) into the polymerization vessel at a constant feed rate.

It is preferred that the process comprises introducing M(2) into the polymerization vessel continuously.

It is preferred that the process comprises introducing M(1), after Δt(1), into the polymerization vessel at a constant feed rate.

It is preferred that the process comprises introducing M(1), after Δt(1), into the polymerization vessel continuously.

Preferably the first polymerization period Δt(1)<the second polymerization period Δt(2).

Preferably Δt(2): Δt(1) is in the range of from 1:1 to 5:1, more preferably in the range of from 1.25:1 to 4:1, more preferably in the range of from 1.5:1 to 3:1.

Preferably the co-polymerization into the polymerization vessel according (iii) is conducted at a temperature in the range of from 70 to 100° C., more preferably in the range of from 80 to 90° C.

Preferably the co-polymerization into the polymerization vessel according (iv) is conducted at a temperature in the range of from 70 to 100° C., more preferably in the range of from 80 to 90° C.

Preferably from 95 to 100 weight-%, more preferably from 98 to 100 weight-%, of the polymers comprised in D(P) after Δt(2) are based on the ethylenically unsaturated monomers comprised in M(1) and M(2).

The process of the present invention preferably further comprises
(v) introducing, after Δt(2), water and one or more additives into the polymerization vessel, wherein more preferably each additive is selected from the group consisting of a base, more preferably ammonia or sodium hydroxide, a defoamer, a biocide, a radical generating compound, preferably ascorbic acid and/or tert-butyl hydroperoxide, and a mixture of two or more thereof. The base is more preferably ammonia.

It is preferred that the process of the present invention consists of (i), (ii), (iii), (iv) and more preferably (v).

### Aqueous Polymer Dispersion D(P)

The present invention further relates to an aqueous polymer dispersion obtainable or obtained by a process according to the present invention and as defined in the foregoing.

Preferably the aqueous polymer dispersion has a polymer content in the range of from 40 to 70 weight-%, more preferably in the range of from 42 to 60 weight-%, more preferably in the range of from 45 to 55 weight-% based on the total weight of the aqueous polymer dispersion, the polymer content more preferably being determined as described in Reference Example 1.1.

Preferably the aqueous polymer dispersion has a monomodal particle size distribution.

Preferably the particles of the aqueous polymer dispersion have an average diameter in the range of from 30 to 400 nm, more preferably from 50 to 160 nm, more preferably from 80 to 120 nm, more preferably being determined as described in Reference Example 1.3.

Preferably the aqueous polymer dispersion has a pH in the range of from 5 to 10, more preferably in the range of from 5.5 to 9.

Preferably the aqueous polymer dispersion has a viscosity in the range of from 150 to 1500 mPas, more preferably in the range of from 200 to 1000 mPas, more preferably in the range of from 200 to 950 mPas, more preferably in the range of from 250 to 910 mPas, the viscosity being preferably determined as described in Reference Example 1.8. More preferably the aqueous polymer dispersion has a viscosity in the range of from 150 to 1500 mPas, more preferably in the range of from 200 to 1000 mPas, more preferably in the range of from 200 to 950 mPas, more preferably in the range of from 250 to 910 mPas and a polymer content in the range of from 45 to 55 weight-% based on the total weight of the aqueous polymer dispersion.

Preferably the aqueous polymer dispersion has a polymer content in the range of from 45 to 55 weight-%, based on the total weight of the aqueous polymer dispersion and a viscosity in the range of from 250 to 500 mPas. Alternatively, the aqueous polymer dispersion has a polymer content in the range of from 45 to 55 weight-%, more preferably from 48.5 to 55 weight-%, based on the total weight of the aqueous polymer dispersion and a viscosity in the range of from 600 to 910 mPas.

### Use/Applications

The present invention further relates to a use of an aqueous polymer dispersion according to the present invention as binder for coatings, preferably decorative coatings.

The present invention further relates to a coating comprising an aqueous polymer dispersion according to the present invention in an amount in the range of from 5 to 50 weight-%, preferably in the range of from 10 to 40 weight-%, based on the weight of the coating. The coating is preferably a paint.

Preferably the coating further comprises a pigment, the coating more preferably having a pigment volume concentration (PVC) in the range of from 10 to 50, more preferably in the range of from 20 to 50, more preferably in the range of from 25 to 40.

In the context of the present invention, it is noted that the proportion of the pigments and fillers in coatings can be described by the known pigment volume concentration (PVC) as mentioned above. Such PVC describes the ratio of the volume of pigments (V_{P}) and fillers (V_{F}) relative to the total volume, consisting of the volumes of binders (V_{B}), pigments (V_{P}) and fillers (V_{F}) in a dried coating in percent: PVC=(V_{P}+V_{F})×100/(V_{P}+V_{F}+V_{B}).

Preferably the pigment is selected from the group consisting of inorganic pigment, organic pigment and a mixture of two or more thereof, wherein the inorganic pigment preferably is titanium dioxide.

Suitable pigments different from the TiO₂ pigment are, for example, inorganic white pigments such as barium sulfate, zinc oxide, zinc sulfide, basic lead carbonate, antimony trioxide, litho-pone (zinc sulfide+barium sulfate), or colored pigments, for example one or more of iron ox-ides, carbon black, graphite, zinc yellow, zinc green, ultramarine, manganese black, antimony black, manganese violet, Prussian blue and Paris green.

In addition to the inorganic pigments, the coating of the present invention may also preferably comprise organic color pigments. Said organic color pigments are more preferably one or more of sepia, gamboge, Cassel brown, toluidine red, para red, Hansa yellow, indigo, azo dyes, anthraquinonoid and indigoid dyes, and also dioxazine, quinacridone pigments, phthalocyanine pigments, isoindolinone pigments. The coating may also preferably comprises or metal complex pigments. Also suitable are synthetic white pigments with air inclusions to enhance light scattering, such as the Ropaque® and AQACell® dispersions. Additionally suitable pigments are the Luconyl® brands from BASF SE, for example Luconyl® yellow, Luconyl® brown and Luconyl® red, particularly the transparent versions.

The coating of the present invention preferably comprises one or more of wetting agents or dispersants, filming auxiliaries, thickeners, leveling agents, biocides, defoamers, opacifiers, fillers and curing catalysts.

In the context of the present invention, it is noted that the glass transition temperature of the polymer dispersion particles is governed by the monomer composition and thus by composition of the monomers to be polymerized. Therefore, by choosing proper amounts of monomers in the first aqueous mixture M(1) and in the second aqueous mixture M(2), the glass transition temperature of the polymer to be obtained can be adjusted. According to T. G. Fox, Bulletin of the American Physical Society 1, page 123 (1956 [Ser. II]) and according to Ullmann's Encyclopedia of Industrial Chemistry (vol. 19, page 18, 4th Edition, Verlag Chemie, Weinheim, 1980), the following is a good approximation of the glass transition temperature of no more than lightly cross-linked copolymers:

$$1 / Tg = {x}_{1} / {Tg}_{1} + {x}_{2} / {Tg}_{2} + … {x}_{n} / {Tg}_{n} ,$$

where x₁, x₂, . . . xₙ are the mass fractions of the monomers 1, 2, . . . n and Tg₁, Tg₂, . . . Tgₙ are the glass transition temperatures in degrees Kelvin of the polymers synthesized from only one of the monomers 1, 2, . . . n at a time. The Tg values for the homopolymers of most monomers are known and listed, for example, in Ullmann's Encyclopedia of Industrial Chemistry (vol. A21, page 169, 5^{th} Edition, Verlag Chemie, Weinheim, 1992); further sources of glass transition temperatures of homopolymers are, for example, J. Brandrup, E. H. Immergut, Polymer Handbook, 1^{st} Edition—J. Wiley, New York 1966, 2^{nd} Edition—J. Wiley, New York 1975, and 3^{rd} Edition—J. Wiley, New York 1989.

In the context of the present invention, the term “different” for example in the expression “different monomers of formula . . . ” preferably means that the monomers of said formula are different chemically and physically.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 3”, every embodiment in this range is meant to be explicitly disclosed for the skilled person, i.e. the wording of this term is to be understood by the skilled person as being synonymous to “The process of any one of embodiments 1, 2 and 3”. Further, it is explicitly noted that the following set of embodiments represents a suitably structured part of the general description directed to preferred aspects of the present invention, and thus, suitably supports, but does not represent the claims of the present invention.
1. A process for preparing an aqueous polymer dispersion D(P), the process comprising
   (i) providing a first aqueous mixture M(1) comprising water and ethylenically unsaturated monomers, wherein at least x weight-% of said ethylenically unsaturated monomers consist of one or more monomers according to formula (I)

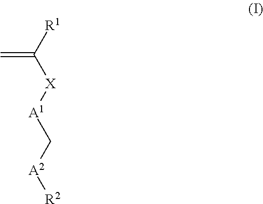

wherein R¹ is H or CH₃, X is CO or CH₂, A¹ is O or NH, A² is selected from the group consisting of CH₂, C(CH₃)₂ and CH(OH) and R² is selected from the group consisting of an ester group, an amido group, a urea group, an alkylamine group, a carbonyl group, an alkyl group and an alkoxy group, wherein from 95 to 100 weight-% of M(1) consist of water and said ethylenically unsaturated monomers;
(ii) providing a second aqueous mixture M(2) comprising water and at least two different ethylenically unsaturated monomers, wherein from 55 to 98 weight-% of said unsaturated monomers consist of one or more of vinyl aromatic monomers, C₁-C₂₀-alkyl esters of methacrylic acid and C₁-C₂₀-alkyl esters of acrylic acid, and wherein y weight-% of said ethylenically unsaturated monomers consist of the one or more monomers according to formula (I) with 0≤y<x, and wherein from 95 to 100 weight-% of M(2) consist of water and said ethylenically unsaturated monomers;
(iii) introducing M(2) into a polymerization vessel and subjecting the ethylenically unsaturated monomers comprised in M(2) to co-polymerization for a first polymerization period Δt(1), obtaining an intermediate mixture M(i);
(iv) introducing, after Δt(1), M(1) into the polymerization vessel comprising M(i), admixing M(1) and M(i) obtaining a polymerization mixture M(P), and subjecting the ethylenically unsaturated monomers to co-polymerization, obtaining, after a second polymerization period Δt(2), the aqueous polymer dispersion D(P), wherein at least 95 weight-% of the polymers comprised in D(P) after Δt(2) are based on the ethylenically unsaturated monomers comprised in M(1) and M(2).
2. The process of embodiment 1, wherein Tg(2)>Tg(1), Tg(2) being the theoretical glass transition temperature (Tg) of the polymer which would be obtained from polymerization of the monomers of the mixture M(2) and Tg(1) being the theoretical glass transition temperature (Tg) of the polymer which would be obtained from polymerization of the monomers of the mixture M(1), wherein said theoretical glass transition temperatures Tg(1) and Tg(2) are determined according to the Fox equation;
   preferably Tg(2)−Tg(1)>30° C., more preferably Tg(2)−Tg(1)>60° C., more preferably Tg(2)−Tg(1)>80° C.
3. The process of embodiment 1 or 2, wherein Tg(2)>30° C., preferably Tg(2)>60° C., more preferably Tg(2)>75° C., more preferably 75° C.<Tg(2)<110° C., Tg(2) being the theoretical glass transition temperature (Tg) of the polymer which would be obtained from polymerization of the monomers of the mixture M(2);
   wherein preferably Tg(1)<−5° C., more preferably Tg(1)<−15° C., more preferably Tg(1)<−20° C., more preferably −40° C.<Tg(1)<−20° C., Tg(1) being the theoretical glass transition temperature (Tg) of the polymer which would be obtained from polymerization of the monomers of the mixture M(1).
4. The process of any one of embodiments 1 to 3, wherein, in formula (I), R² is selected from the group consisting of an ester group, an amido group, a urea group and a dialkylamine group.
5. The process of embodiment 4, wherein, in formula (I), R² is an ester group, R¹ is CH₃, X is CO, A¹ is O and A² is CH₂, wherein preferably the ester group R² is —OCORₐ, wherein more preferably Rₐ is —CH₂COCH₃, the monomer of formula (I), comprised in the first aqueous mixture M(1), being more preferably acetoacetoxyethyl methacrylate.
6. The process of embodiment 4, wherein, in formula (I), R² is a urea group, wherein preferably the urea group is —NR_{c1}(CO)NHR_{c2}, wherein each of R_{c1} and R_{c2} is independently H or a C₁-C₂-alkyl group;
wherein more preferably R_{c1} is a C₁-C₂-alkyl group, more preferably a C₁-alkyl group, and R_{c2} is a C₁-C₂-alkyl group, more preferably a C₁-alkyl group, wherein R_{c1} and R_{c2} are linked.
7. The process of embodiment 6, wherein, in formula (I), R² is a urea group, R¹ is CH₃, X is CO, A¹ is O and A² is CH₂; wherein preferably the monomer of formula (I), comprised in the first aqueous mixture M(1), is ureido methacrylate.
8. The process of any one of embodiments 1 to 7, wherein the monomers according to formula (I), comprised in the first aqueous mixture M(1), are at least two different monomers of formula (I), preferably the at least two monomers being
   a monomer, wherein R¹ is CH₃, X is CO, A¹ is O, A² is CH₂ and R² is an ester group, and
   a monomer, wherein R¹ is CH₃, X is CO, A¹ is O, A² is CH₂ and R² is a urea group; wherein preferably the monomers of formula (I) are acetoacetoxyethyl methacrylate and ureido methacrylate.
9. The process of any one of embodiments 1 to 6, wherein the monomers according to formula (I), comprised in the first aqueous mixture M(1), are the same monomers, wherein R¹ is CH₃, X is CO, A¹ is O, A² is CH₂ and R² is an ester group or wherein R¹ is CH₃, R¹ is CH₃, X is CO, A¹ is O, A² is CH₂ and R² is a urea group.
10. The process of embodiment 9, wherein the monomers according to formula (I) are ureido methacrylate.
11. The process of embodiment 9, wherein the monomers according to formula (I) are acetoacetoxyethyl methacrylate.
12. The process of embodiment 4, wherein the monomers according to formula (I), comprised in the first aqueous mixture M(1), are the same monomers, wherein R¹ is CH₃, X is CO, A¹ is O, A² is C(CH₃)₂ and R² is an amido group, preferably —NHCOCH₂R, wherein R more preferably is an acetyl group; or
   wherein the monomers according to formula (I), comprised in the first aqueous mixture M(1), are at least two different monomers of formula (I), wherein the at least two monomers are
   a monomer, wherein R¹ is CH₃, X is CO, A¹ is O, A² is CH₂ and R² is an ester group or a urea group and
   a monomer, wherein R¹ is CH₃, X is CO, A¹ is O, A² is C(CH₃)₂ and R² is an amido group, preferably-NHCOCH₂R, wherein R more preferably is an acetyl group.
13. The process of embodiment 4, wherein the monomers according to formula (I), comprised in the first aqueous mixture M(1), are the same monomers, wherein R¹ is H, X is CH₂, A¹ is O, A² is CH(OH) and R² is an alkylamine group, preferably —CH₂—NH—(CH₂)₂—R, wherein R more preferably is a urea group, the urea group being more preferably as defined in embodiment 6; or
   wherein the monomers according to formula (I), comprised in the first aqueous mixture M(1), are at least two different monomers of formula (I), wherein the at least two monomers are
   a monomer, wherein R¹ is CH₃, X is CO, A¹ is O, A² is CH₂ and R² is an ester group or a urea group and
   a monomer, wherein R¹ is H, X is CH₂, A¹ is O, A² is CH(OH) and R² is a dialkylamine group, preferably —CH₂—NH—(CH₂)₂—R, wherein R more preferably is a urea group, the urea group being more preferably as defined in embodiment 6.
14. The process of any one of embodiments 1 to 13, wherein x is in the range of from 0.25 to 15, preferably in the range of from 0.5 to 10, more preferably in the range of from 2 to 7, more preferably in the range of from 2 to 3 or more preferably in the range of from 4 to 6.
15. The process of any one of embodiments 1 to 14, wherein the ethylenically unsaturated monomers comprised in the first aqueous mixture M(1) further comprises monomers which exhibit a Bronsted acidic group, wherein the monomers which exhibit a Bronsted acidic group are preferably selected from the group consisting of monoethylenically unsaturated monocarboxylic acids having 3 to 6 carbon atoms, monoethylenically unsaturated dicarboxylic acids having 4 to 6 carbon atoms and a mixture thereof, more preferably monoethylenically unsaturated monocarboxylic acids having 3 to 6 carbon atoms;
   wherein preferably from 0.5 to 5 weight-%, more preferably from 1 to 5 weight-%, more preferably from 2 to 4 weight-%, of the ethylenically unsaturated monomers comprised in the first aqueous mixture M(1) consist of the monomers which exhibit a Bronsted acidic group.
16. The process of embodiment 15, wherein the monoethylenically unsaturated monocarboxylic acid having 3 to 6 carbon atoms is one or more of methacrylic acid, acrylic acid, crotonic acid, 2-ethylpropenoic acid, 2-propylpropenoic acid, 2-acryloxyacetic acid and 2-methacycloxyacetic acid, preferably one or more of methacrylic acid and acrylic acid, more preferably methacrylic acid or acrylic acid.
17. The process of embodiment 15 or 16, wherein, in the first aqueous mixture M(1), the ratio of the masses of the monomers which exhibit a Bronsted acidic group, m₁(a), to the one or more monomers of formula (I), m₁(monomers), m₁(a):m₁(monomers), is in the range of from 0.25:1 to 3:1, preferably in the range of from 0.3:1 to 2:1, more preferably in the range of from 0.4:1 to 1.25:1, more preferably in the range of from 0.4:1 to 0.75:1 or more preferably in the range of from 1:1 to 1.25:1.
18. The process of any one of embodiments 1 to 17, wherein the ethylenically unsaturated monomers comprised in the first aqueous mixture M(1) further comprises one or more of C₁-C₂₀-alkyl esters of acrylic acid and C₁-C₂₀-alkylesters of methacrylic acid, preferably one or more of C₂-C₁₀ alkyl esters of acrylic acid and C₁-C₁₀ alkyl esters of methacrylic acid, more preferably comprises C₂-C₁₀ alkyl esters of acrylic acid and C₁-C₁₀ alkyl esters of methacrylic acid.
19. The process of embodiment 18, wherein the C₁-C₂₀-alkyl esters of acrylic acid is selected from the group consisting of methyl acrylate, ethyl acrylate, n-propyl acrylate, isopropyl-acrylate, n-butyl acrylate, 2-butyl acrylate, isobutyl acrylate, n-pentyl acrylate, isoamyl acrylate, n-hexyl acrylate, n-octyl acrylate, 2-octyl acrylate, 2-ethylhexylacrylate, n-decyl acrylate, 2-propylheptyl acrylate, lauryl acrylate, C₁₂-C₁₄-alkyl acrylate, stearyl acrylate, isobornyl acrylate, and a mixture of two or more thereof.
20. The process of embodiment 18, wherein the C₂-C₁₀ alkyl ester of acrylic acid is selected from the group consisting of ethyl acrylate, 2-ethylhexyl acrylate, n-butyl acrylate, iso-butyl acrylate, isoamyl acrylate, n-hexyl acrylate, n-octyl acrylate, 2-octyl acrylate, 2-propylheptyl acrylate, and a mixture of two or more thereof, preferably selected from the group consisting of 2-ethylhexyl acrylate, 2-octyl acrylate, iso-butyl acrylate, ethyl acrylate, n-butyl acrylate, acrylate and a mixture of two or more thereof, more preferably selected from the group consisting of 2-ethylhexyl acrylate, 2-octyl acrylate, iso-butyl acrylate, ethyl acrylate and a mixture thereof, more preferably is 2-ethylhexyl acrylate.
21. The process of any one of embodiments 18 to 20, wherein from 40 to 90 weight-%, preferably from 55 to 85 weight-%, more preferably from 65 to 80 weight-%, of the ethylenically unsaturated monomers comprised in the first aqueous mixture M(1) consist of C₁-C₂₀-alkyl esters of acrylic acid, preferably of C₂-C₁₀ alkyl ester of acrylic acid monomers.
22. The process of embodiment 18, wherein the C₁-C₂₀-alkyl esters of methacrylic acid is selected from the group consisting of methyl methacrylate, ethyl methacrylate, propyl methacrylate, n-butyl methacrylate, isobutyl methacrylate, cyclohexyl methacrylate, benzyl methacrylate, isobornyl methacrylate, n-pentyl methacrylate, n-hexyl methacrylate, n-octyl methacrylate, 2-ethylhexyl methacrylate, n-decyl methacrylate, 2-propylheptyl methacrylate, lauryl methacrylate, C₁₂-C₁₄-alkyl methacrylate, stearyl methacrylate and a mixture of two or more thereof.
23. The process of embodiment 18, wherein the C₁-C₁₀ alkyl ester of methacrylic acid is selected from the group consisting of methyl methacrylate, ethyl methacrylate, propyl methacrylate, n-butyl methacrylate, isobutyl methacrylate, cyclohexyl methacrylate, benzyl methacrylate, isobornyl methacrylate, and a mixture of two or more thereof, preferably selected from the group consisting of methyl methacrylate, ethyl methacrylate and isobornyl methacrylate, more preferably methyl methacrylate.
24. The process of any one of embodiments 18 to 23, wherein from 9.25 to 40 weight-%, preferably from 13.5 to 30 weight-%, more preferably from 16 to 24 weight-% of the ethylenically unsaturated monomers comprised in the first aqueous mixture M(1) consist of C₁-C₂₀ alkyl esters of methacrylic acid monomers, preferably of C₁-C₁₀ alkyl esters of methacrylic acid monomers.
25. The process of any one of embodiments 1 to 24, wherein the first aqueous mixture M(1) further comprises one or more surfactants, wherein the surfactants are each selected from the group consisting of an anionic surfactant, a non-ionic surfactant and a mixture thereof, wherein preferably from 0 to 5 weight-%, more preferably from 0.1 to 3 weight-%, more preferably from 0.5 to 2.8 weight-%, of the first aqueous mixture M(1) consist of the one or more surfactants;
   wherein the anionic surfactant preferably comprises at least one anionic group, which is more preferably selected from the group consisting of phosphate, phosphonate, sulfate and sulfonate groups;
   wherein, when the anionic surfactant comprises at least one anionic group, the anionic surfactant more preferably is in the form of its alkali metal salt, more preferably its sodium salt or ammonium salt.
26. The process of embodiment 25, wherein the anionic surfactant is an anionic emulsifier comprising at least one a sulfate group, a sulfonate group, a phosphate group or a phosphonate group;
   wherein preferably the surfactants comprised in the first aqueous mixture M(1) comprises an anionic surfactant comprising a phosphate group or phosphonate group and an anionic surfactant comprising a sulfate group or sulfonate group.
27. The process of embodiment 25 or 26, wherein the anionic surfactant is an anionic emulsifier comprising a sulfate group or a sulfonate group;
   wherein preferably said anionic surfactant is one or more of a salt of alkyl sulfates, more preferably C₈-C₂₂-alkyl sulfates, a salt of sulfuric monoesters of ethoxylated alkanols, more preferably sulfuric monoesters of ethoxylated C₈-C₂₂-alkanols, more preferably having an ethoxylation level (EO level) in the range of from 2 to 40, a salt of alkylsulfonic acids, more preferably C₈-C₂₂-alkylsulfonic acids, a salt of dialkyl esters, more preferably di-C₄-C₁₈-alkyl esters of sulfosuccinic acid, a salt of alkylbenzenesulfonic acids, more preferably C₄-C₂₂-alkylbenzenesulfonic acids, and a salt of mono- or disulfonated alkyl-substituted diphenyl ethers, more preferably bis(phenylsulfonic acid) ethers bearing a C₄-C₂₄-alkyl group on one or both aromatic rings;
   wherein the salt more preferably is an alkali metal salt or an ammonium salt.
28. The process of embodiment 27, wherein said anionic surfactant is one or more of a salt of alkyl sulfates, more preferably C₈-C₂₂-alkyl sulfates, a salt, preferably an alkali metal salt, of sulfuric monoesters of ethoxylated alkanols, more preferably sulfuric monoesters of ethoxylated C₈-C₂₂-alkanols, more preferably having an ethoxylation level (EO level) in the range of from 2 to 40, a salt, preferably an alkali metal salt, of mono- or disulfonated alkyl-substituted diphenyl ethers, more preferably bis(phenylsulfonic acid) ethers bearing a C₄-C₂₄-alkyl group on one or both aromatic rings.
29. The process of any one of embodiments 24 to 28, wherein the anionic surfactant is an anionic surfactant comprising a phosphate or phosphonate group;
   wherein preferably said anionic surfactant is one or more of a salt of mono- or dialkyl phosphates, more preferably C₈-C₂₂-alkyl phosphates, a salt of phosphoric monoesters of C₂-C₃-alkoxylated alkanols, more preferably having an alkoxylation level in the range of from 2 to 40, more preferably in the range of from 3 to 30, a salt of alkylphosphonic acids, more preferably C₈-C₂₂-alkylphosphonic acids and a salt of alkylbenzenephosphonic acids, more preferably C₄-C₂₂-alkylbenzenephosphonic acids;
   wherein the salt of phosphoric monoesters of C₂-C₃-alkoxylated alkanols more preferably is a salt of phosphoric monoesters of ethoxylated C₈-C₂₂-alkanols, more preferably having an ethoxylation level (EO level) in the range of from 2 to 40, a salt of phosphoric monoesters of propoxylated C₈-C₂₂-alkanols, more preferably having a propoxylation level (PO level) in the range of from 2 to 40, and a salt of phosphoric monoesters of ethoxylated-co-propoxylated C₈-C₂₂-alkanols, more preferably having an EO level in the range of from 1 to 20 and a PO level of 1 to 20.
30. The process of any one of embodiments 1 to 29, wherein from 95 to 100 weight-%, preferably from 97 to 99.9 weight-%, more preferably in the range of from 97.2 to 99.5 weight-%, of M(1) consist of water and the ethylenically unsaturated monomers.
31. The process of any one of embodiments 1 to 30, wherein the first aqueous mixture M(1) is an emulsion.
32. The process of any one of embodiments 1 to 31, wherein from 98 to 100 weight-%, preferably from 99 to 100 weight-%, more preferably from 99.5 to 100 weight-%, more preferably from 99.9 to 100 weight-%, of the first aqueous mixture M(1) consist of water and the ethylenically unsaturated monomers, and preferably one or more surfactants as defined in any one of embodiments 25 to 29.
33. The process of any one of embodiments 1 to 32, wherein from 98 to 100 weight-%, preferably from 99 to 100 weight-%, more preferably from 99.5 to 100 weight-%, more preferably from 99.9 to 100 weight-%, of the ethylenically unsaturated monomers comprised in the first aqueous mixture M(1) consist of the one or more monomers of formula (I), the monomers which exhibit a Bronsted acidic group as defined in any one of embodiment 15 to 17, C₁-C₂₀ alkyl esters of acrylic acid as defined in embodiment 19, preferably-C₂-C₁₀ alkyl esters of acrylic acid as defined in embodiment 20, and C₁-C₂₀-alkylesters of methacrylic acid as defined in embodiment 22, preferably C₁-C₁₀ alkyl ester of methacrylic acid as defined in embodiment 23.
34. The process of any one of embodiments 1 to 33, wherein, in the first aqueous mixture M(1), the ratio of the masses of water, m₁(H₂O), to the ethylenically unsaturated monomers, m₁(monomers), is in the range of from 0.1:1 to 0.5:1, preferably in the range of from 0.2:1 to 0.45:1, more preferably in the range of from 0.25:1 to 0.4:1.
35. The process of any one of embodiments 1 to 34, wherein from 65 to 95 weight-%, preferably from 80 to 95 weight-%, more preferably from 85 to 93 weight-%, of the ethylenically unsaturated monomers comprised in the second aqueous mixture M(2) consist of one or more of vinyl aromatic monomers, C₁-C₂₀-alkyl esters of methacrylic acid, and C₁-C₂₀-alkyl esters of acrylic acid, preferably one or more of styrene, methyl methacrylate, ethyl acrylate, n-propyl acrylate, isopropyl-acrylate, n-butyl acrylate, 2-butyl acrylate, isobutyl acrylate, t-butyl methacrylate, t-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C12/C14-alkyl acrylate, stearyl acrylate, cyclohexylmethacrylate, isobornyl acrylate, isobornyl methacrylate, 2-methylstyrene, 4-methylstyrene, 2-n-butylstyrene, 4-n-butylstyrene, α-methylstyrene and vinyl acetate.
36. The process of embodiment 35, wherein from 65 to 95 weight-%, preferably from 80 to 95 weight-%, more preferably from 85 to 93 weight-%, of the ethylenically unsaturated monomers comprised in the second aqueous mixture M(2) consist of one or more of styrene, methyl methacrylate, ethyl methacrylate, t-butyl methacrylate, t-butyl acrylate, cyclohexylmethacrylate, benzyl methacrylate, isobornyl acrylate, isobornyl methacrylate, and vinyl acetate; preferably one or more of styrene, methyl methacrylate, t-butyl methacrylate, t-butyl acrylate, cyclohexylmethacrylate and vinyl acetate, more preferably of one or more of styrene and methyl methacrylate, more preferably of styrene or methyl methacrylate, more preferably styrene.
37. The process of any one of embodiments 1 to 34, wherein the ethylenically unsaturated monomers comprised in the second aqueous mixture M(2) comprise styrene and methyl methacrylate;
   wherein the weight ratio of styrene to methyl methacrylate in the second aqueous mixture M(2) is preferably in the range of from 0.2:1 to 4:1, more preferably in the range of from 0.3:1 to 3:1.
38. The process of embodiment 37, wherein from 65 to 95 weight-%, preferably from 80 to 95 weight-%, more preferably from 85 to 93 weight-%, of the ethylenically unsaturated monomers comprised in the second aqueous mixture M(2) consist of styrene and methyl methacrylate.
39. The process of any one of embodiments 1 to 37, wherein the ethylenically unsaturated monomers comprised in the second aqueous mixture M(2) further comprises monomers which exhibit a Bronsted acidic group comprised in M(2), said monomers are selected from the group consisting of monoethylenically unsaturated monocarboxylic acids having 3 to 6 carbon atoms, monoethylenically unsaturated dicarboxylic acids having 4 to 6 carbon atoms, and mixture of two or more thereof, preferably monoethylenically unsaturated monocarboxylic acids having 3 to 6 carbon atoms.
40. The process of embodiment 39, wherein the monoethylenically unsaturated monocarboxylic acids having 3 to 6 carbon atoms are one or more of methacrylic acids, acrylic acids, crotonic acids, 2-ethylpropenoic acids, 2-propylpropenoic acids, 2-acryloxyacetic acids and 2-methacyloxyacetic acids, preferably one or more of methacrylic acids and acrylic acids, more preferably methacrylic acids or acrylic acids.
41. The process of embodiment 39 or 40, wherein from 1.0 to 10 weight-%, preferably from 1.5 to 5 weight-%, more preferably from 2 to 5 weight-%, of the ethylenically unsaturated monomers comprised in the second aqueous mixture M(2) consist of monomers which exhibit a Bronsted acidic group.
42. The process of any one of embodiments 1 to 41, wherein the ethylenically unsaturated monomers comprised in the second aqueous mixture M(2) further comprises C₁-C₂₀-alkyl esters of acrylic acid, wherein the C₁-C₂₀-alkyl ester of acrylic acid is preferably selected from the group consisting of methyl acrylate, ethyl acrylate, n-propyl acrylate, isopropyl-acrylate, n-butyl acrylate, 2-butyl acrylate, isobutyl acrylate, n-pentyl acrylate, iso-amyl acrylate, n-hexyl acrylate, n-octyl acrylate, 2-octyl acrylate, 2-ethylhexylacrylate, n-decyl acrylate, 2-propylheptyl acrylate, lauryl acrylate, C12/C14-alkyl acrylate, stearyl acrylate, isobornyl acrylate, and a mixture of two or more thereof;
   wherein the ethylenically unsaturated monomers comprised in the second aqueous mixture M(2) preferably further comprises C₂-C₁₀ alkyl esters of acrylic acid, wherein the ester of acrylic acid is more preferably selected from the group consisting of n-butyl acrylate, iso-butyl acrylate, iso-amyl acrylate, n-hexyl acrylate, n-octyl acrylate, 2-octyl acrylate, 2-ethylhexyl acrylate, 2-propylheptyl acrylate, isobornyl acrylate, and a mixture of two or more thereof, more preferably selected from the group consisting of n-butyl acrylate, iso-butyl acrylate, iso-amyl acrylate, 2-octyl acrylate, 2-ethylhexyl acrylate and a mixture of two or more thereof, more preferably selected from the group consisting of n-butyl acrylate, 2-ethylhexyl acrylate and a mixture thereof, more preferably is 2-ethylhexyl acrylate.
43. The process of embodiment 42, wherein from 3.5 to 25 weight-%, preferably from 3.5 to 15 weight-%, more preferably from 5 to 10 weight-%, of the ethylenically unsaturated monomers comprised in the second aqueous mixture M(2) consist of C₁-C₂₀-alkyl esters of acrylic acid, preferably C₂-C₁₀ alkyl esters of acrylic acid.
44. The process of any one of embodiments 1 to 43, wherein 0≤y<0.5, preferably 0≤y<0.2 more preferably 0≤y<0.1.
45. The process of any one of embodiments 1 to 44, wherein from 95 to 100 weight-%, preferably from 97 to 99.9 weight-%, more preferably from 97.2 to 99.5 weight-%, of M(2) consist of water and at least two different ethylenically unsaturated monomers.
46. The process of any one of embodiments 1 to 45, wherein the second aqueous mixture M(2) further comprises one or more surfactants, wherein the surfactants are each selected from the group consisting of an anionic surfactant, a non-ionic surfactant and a mixture thereof,
   wherein the anionic surfactant preferably comprises at least one anionic group, which is more preferably selected from the group consisting of phosphate, phosphonate, sulfate and sulfonate groups;
   wherein, when the anionic surfactant comprises at least one anionic group, the anionic surfactant more preferably is in the form of its alkali metal salt, more preferably its sodium salt or ammonium salt.
47. The process of embodiment 45, wherein from 0 to 5 weight-%, preferably from 0.1 to 3 weight-%, more preferably from 0.5 to 2.8 weight-%, of the second aqueous mixture M(2) consist of the one or more surfactants.
48. The process of embodiment 46 or 47, wherein the anionic surfactant comprised in the second aqueous mixture M(2) is an anionic emulsifier comprising at least one a sulfate group, a sulfonate group, a phosphate group or a phosphonate group;
   wherein preferably the surfactants comprised in the second aqueous mixture M(2) comprises an anionic surfactant comprising a phosphate group or phosphonate group and an anionic surfactant comprising a sulfate group or sulfonate group.
49. The process of any one of embodiments 46 to 48, wherein the anionic surfactant comprised in the second aqueous mixture M(2) is an anionic emulsifier comprising a sulfate group or a sulfonate group;
   wherein preferably said anionic surfactant is one or more of a salt of alkyl sulfates, more preferably C8-C22-alkyl sulfates, a salt of sulfuric monoesters of ethoxylated alkanols, more preferably sulfuric monoesters of ethoxylated C8-C22-alkanols, more preferably having an ethoxylation level (EO level) in the range of from 2 to 40, a salt of alkylsulfonic acids, more preferably C8-C22-alkylsulfonic acids, a salt of dialkyl esters, more preferably di-C4-C18-alkyl esters of sulfosuccinic acid, a salt of alkylbenzenesulfonic acids, more preferably C4-C22-alkylbenzenesulfonic acids, and a salt of mono- or disulfonated alkyl-substituted diphenyl ethers, more preferably bis(phenylsulfonic acid) ethers bearing a C4-C24-alkyl group on one or both aromatic rings;
   wherein the salt more preferably is an alkali metal salt or an ammonium salt.
50. The process of embodiment 49, wherein said anionic surfactant is one or more of a salt of alkyl sulfates, more preferably C8-C22-alkyl sulfates, a salt, preferably an alkali metal salt, of sulfuric monoesters of ethoxylated alkanols, more preferably sulfuric monoesters of ethoxylated C8-C22-alkanols, more preferably having an ethoxylation level (EO level) in the range of from 2 to 40, a salt, preferably an alkali metal salt, of sulfuric monoesters of ethoxylated alkanols, preferably sulfuric monoesters of ethoxylated C8-C22-alkanols, more preferably having an ethoxylation level (EO level) in the range of from 2 to 40, a salt, preferably an alkali metal salt, of mono- or disulfonated alkyl-substituted diphenyl ethers, more preferably bis(phenylsulfonic acid) ethers bearing a C4-C24-alkyl group on one or both aromatic rings.
51. The process of any one of embodiments 46 to 49, wherein the anionic surfactant comprised in the second aqueous mixture M(2) is an anionic surfactant comprising a phosphate or phosphonate group;
   wherein preferably said anionic surfactant is one or more of a salt of mono- or dialkyl phosphates, more preferably C₈-C₂₂-alkyl phosphates, a salt of phosphoric monoesters of C₂-C₃-alkoxylated alkanols, more preferably having an alkoxylation level in the range of from 2 to 40, more preferably in the range of from 3 to 30, a salt of alkylphosphonic acids, more preferably C₈-C₂₂-alkylphosphonic acids and a salt of alkylbenzenephosphonic acids, more preferably C₄-C₂₂-alkylbenzenephosphonic acids;
   wherein the salt of phosphoric monoesters of C₂-C₃-alkoxylated alkanols more preferably is a salt of phosphoric monoesters of ethoxylated C₈-C₂₂-alkanols, more preferably having an ethoxylation level (EO level) in the range of from 2 to 40, a salt of phosphoric monoesters of propoxylated C₈-C₂₂-alkanols, more preferably having a propoxylation level (PO level) in the range of from 2 to 40, and a salt of phosphoric monoesters of ethoxylated-co-propoxylated C₈-C₂₂-alkanols, more preferably having an EO level in the range of from 1 to 20 and a PO level of 1 to 20.
52. The process of any one of embodiments 46 to 51, wherein the second aqueous mixture M(2) comprises at least two surfactants, which are chemically and physically different from one other.
53. The process of embodiment 52, wherein the second aqueous mixture M(2) comprises an anionic surfactant comprising a phosphate group and an anionic surfactant comprising a sulfate group.
54. The process of any one of embodiments 1 to 53, wherein the second aqueous mixture M(2) is an emulsion.
55. The process of any one of embodiments 1 to 54, wherein from 98 to 100 weight-%, preferably from 99 to 100 weight-%, more preferably from 99.5 to 100 weight-%, more preferably from 99.9 to 100 weight-%, of the second aqueous mixture M(2) consist of water and the ethylenically unsaturated monomers, and preferably one or more surfactants as defined in any one of embodiments 46 to 52.
56. The process of any one of embodiments 1 to 52, wherein from 98 to 100 weight-%, preferably from 99 to 100 weight-%, more preferably from 99.5 to 100 weight-%, more preferably from 99.9 to 100 weight-%, of the ethylenically unsaturated monomers comprised in the second aqueous mixture M(2) consist of the one or more of styrene, methyl methacrylate, t-butyl methacrylate, t-butyl acrylate, cyclohexylmethacrylate and vinyl acetate, monomers which exhibit a Bronsted acidic group as defined in any one of embodiment 38 to 40, and C₁-C₂₀, preferably C₂-C₁₀, alkyl esters of acrylic acid as defined in embodiment 41 or 42.
57. The process of any one of embodiments 1 to 56, wherein, in the second aqueous mixture M(2), the ratio of the masses of water, m₂(H₂O), to the ethylenically unsaturated monomers, m₂(monomers), is in the range of from 0.1:1 to 0.5:1, preferably in the range of from 0.2:1 to 0.45:1, more preferably in the range of from 0.25:1 to 0.4:1.
58. The process of any one of embodiments 1 to 57, wherein the ratio of the masses of the ethylenically unsaturated monomers comprised in M(1), m₁(monomers), to the ethylenically unsaturated monomers comprised in M(2), m₂(monomers), is in the range of from 0.75:1 to 8:1, preferably in the range of from 1:1 to 6:1, more preferably in the range of from 1.25:1 to 4:1, more preferably in the range of from 1.5:1 to 3:1.
59. The process of any one of embodiments 1 to 58, wherein the ratio of the masses of M(1), m(M(1)), and M(2), m(M(2)), m(M(1)):m(M(2)), is in the range of from 0.75:1 to 8:1, preferably in the range of from 1:1 to 6:1, more preferably in the range of from 1.25:1 to 4:1, more preferably in the range of from 1.5:1 to 3:1.
60. The process of any one of embodiments 1 to 59, wherein the polymerization vessel wherein M(2) is introduced according to (iii) comprises water and one or more of an initiator and seed latex, preferably water, seed latex, more preferably polystyrene, and an initiator.
61. The process of any one of embodiments 1 to 62, comprising introducing M(2) into the polymerization vessel at a constant feed rate.
62. The process of any one of embodiments 1 to 61, comprising introducing M(2) into the polymerization vessel continuously.
63. The process of any one of embodiments 1 to 62, comprising introducing M(1), after Δt(1), into the polymerization vessel at a constant feed rate.
64. The process of any one of embodiments 1 to 63, comprising introducing M(1), after Δt(1), into the polymerization vessel continuously.
65. The process of any one of embodiments 1 to 64, wherein the first polymerization period Δt(1)<the second polymerization period Δt(2).
66. The process of embodiment 65, wherein Δt(2): Δt(1) is in the range of from 1:1 to 5:1, preferably in the range of from 1.25:1 to 4:1, more preferably in the range of from 1.5:1 to 3:1.
67. The process of any one of embodiments 1 to 66, wherein co-polymerization into the polymerization vessel according (iii) is conducted at a temperature in the range of from 70 to 100° C., preferably in the range of from 80 to 90° C.;
   wherein preferably co-polymerization into the polymerization vessel according (iv) is conducted at a temperature in the range of from 70 to 100° C., more preferably in the range of from 80 to 90° C.
68. The process of any one of embodiments 1 to 67, wherein from 95 to 100 weight-%, preferably from 98 to 100 weight-%, of the polymers comprised in D(P) after Δt(2) are based on the ethylenically unsaturated monomers comprised in M(1) and M(2).
69. The process of any one of embodiments 1 to 68, further comprising
   (v) introducing, after Δt(2), water and one or more additives into the polymerization vessel, wherein preferably each additive is selected from the group consisting of a base, more preferably ammonia or sodium hydroxide, a defoamer, a biocide, a radical generating compound, preferably ascorbic acid and/or tert-butyl hydroperoxide, and a mixture of two or more thereof.
70. The process of any one of embodiments 1 to 69, consisting of (i), (ii), (iii), (iv) and preferably (v).
71. An aqueous polymer dispersion obtainable or obtained by a process according to any one of embodiments 1 to 70.
72. The aqueous polymer dispersion of embodiment 71, having a polymer content in the range of from 40 to 70 weight-%, preferably in the range of from 42 to 60 weight-%, more preferably in the range of from 45 to 55 weight-% based on the total weight of the aqueous polymer dispersion, preferably being determined as described in Reference Example 1.1.
73. The aqueous polymer dispersion of embodiment 71 or 72, having a monomodal particle size distribution.
74. The aqueous polymer dispersion of any one of embodiments 71 to 73, wherein the particles of the dispersion have an average diameter in the range of from 30 to 400 nm, preferably from 50 to 160 nm, more preferably from 80 to 120 nm, preferably being determined as described in Reference Example 1.3.
75. The aqueous polymer dispersion of any one of embodiment 71 to 74, having a pH in the range of from 5 to 10, preferably in the range of from 5.5 to 9.
76. The aqueous polymer dispersion of any one of embodiments 71 to 75, having a viscosity in the range of from 150 to 1500 mPas, preferably in the range of from 200 to 1000 mPas, more preferably in the range of from 200 to 950 mPas, more preferably in the range of from 250 to 910 mPas, preferably being determined as described in Reference Example 1.8.
77. Use of an aqueous polymer dispersion according to any one of embodiments 71 to 76 as binder for coatings, preferably decorative coatings.
78. A coating comprising an aqueous polymer dispersion according to any one of embodiments 70 to 75 in an amount in the range of from 5 to 50 weight-%, preferably in the range of from 10 to 40 weight-%, based on the weight of the coating; preferably wherein the coating is a paint.
79. The coating of embodiment 78, further comprising a pigment, wherein the coating preferably has a pigment volume concentration (PVC) in the range of from 10 to 50, preferably in the range of from 20 to 50, more preferably in the range of from 25 to 40.
80. The coating of embodiment 79, wherein the pigment is selected from the group consisting of inorganic pigment, organic pigment and a mixture of two or more thereof, wherein the inorganic pigment preferably is titanium dioxide.
81. The coating of embodiments 78 to 80, further comprising one or more of wetting agents or dispersants, filming auxiliaries, thickeners, leveling agents, biocides, defoamers, opacifiers, fillers and curing catalysts.

The present invention is further illustrated by the Examples below.

### EXAMPLES

### Reference Example 1 Measurement Methods

### 1.1 Solids Content

Solids content was determined by spreading 0.5 to 1.5 g wet polymer latex in a sample vessel with a diameter of 4 cm and drying of the latex using a moisture analyzer (device HR 83 from Mettler-Toledo GmbH, Germany) at a temperature of 140° C. until a constant mass was reached. The ratio of the mass after drying to the mass before drying gave the solids content of the polymer dispersion.

### 1.2 Coagulum Formed During Polymerization

After completion of the polymerization the obtained polymer dispersion was filtered through a nylon filter with a 125 μm mesh size and the solid filter content was weighed. The weight of the filter content in relation to total mass of obtained wet polymer dispersion gave the proportion of coagulum in % by weight.

### 1.3 Particle Diameter

The volume-based particle size distributions of the polymer dispersions were measured by capillary hydrodynamic fractionation (HDC) with a “CHDF3000” device (from Matec Applied Sciences, USA) using as column a “PL-PSDA cartridge, Type-2” (Agilent Technologies, USA). Each sample was first diluted to a solids content of 1% by weight, filtered through a filter with pore size 1.2 μm and injected with an autosampler with an injection volume of 25 microL.

### 1.4 Measurement of Wet Adhesion

Wet adhesion on alkyd panels was conducted as follows:

Four paint films per sample were prepared on top of an alkyd coated wood panel which was stored for more than 2 weeks but not longer than 6 weeks using a wet film thickness of 300 μm. The paint films were dried for 1 d (two films) respectively 7 d (2 films). After the drying period a double X-cut is made through the film with a sharp knife. Water was placed on top of the coating for 2 h before the water was removed carefully with a paper towel. Pressure-sensitive tape is applied over the cut. Tape is smoothed into place by using a roller. Tape is removed by pulling it off rapidly back over itself close to an angle of 180°. Adhesion is assessed on a 0 to 5 scale based on the damaged paint film area. The values given is the average of the two replicates.
0=no damage
1=approx. 5% damage
2=approx. 15% damage
3=approx. 35% damage
4=approx. 65% damage
5=strong damage

### 1.5 Measurement of Opacity

Opacity, respectively hiding power, was quantified by spreading rate measurements. These measurements were performed by applying different film thicknesses using a draw-down bar i.e. doctor blade (e.g. 150, 200, 220 and 250 μm wet) onto a defined contrast paper, e.g. Leneta foil with black & white areas and subsequent measurement of contrast ratios. Afterwards, the values are interpolated to yield the so called spreading rate, which is the reciprocal of the volume of the paint per area [m²/L] (inverse of the film thickness) which is required to cover a substrate at a given contrast ratio, e.g. 98% or 99.5%, for a Class II hiding paint according to ISO DIN 13300.

### 1.6 Measurement of Wet Scrub Resistance

The wet scrub resistance (WSR) of the latex paints prepared was tested by means of the nonwoven pad method in accordance with ISO 11998. WSR is assessed on the basis of the weight loss per unit area caused by abrasion and calculated back to an average thickness loss given in μm.

### 1.7 Measurement of Blocking Resistance

Pine panels of 150×50×5 mm were used for testing the blocking resistance. 300 microns of the wet paint were applied. Samples were dried for 24 hours at RT. The test pieces were then stacked face to face in a cross-like fashion for 3 hours at RT, with a pressure of 150 g/cm². After these 3 hours the pieces were separated and rated.
0=films are easy to separate without damage (no sound)
1=films separate without damage (slight sound)
2=films separate with some damage
3=blocking, films show damage after separation, but no film break
4=blocking, films show severe damage after separation, but no film break
5=blocking, films are very hard or not able to separate, severe film break

### 1.8 Viscosity Measurement

Single point viscosity measurements have also been carried out according to ISO2884-1/ASTM D4287 using an ICI high shear cone plate viscometer and according to ASTM D562 using a Stormer type viscometer measuring Krebs Units (KU).

### Starting Materials

Emulsifier solution 1: 31 weight-% solids content—Fatty alcohol C₁₂-C₁₄ ethoxylated sulfate sodium salt in water
Emulsifier solution 2: 20 weight-% solids content—C₁₀-C₁₆ alcohol ethoxylate/propoxylate phosphate terminated ammonium salt in water
Emulsifier solution 3: mixture of isotridecanol ethoxylate (18.5 weight-% solids content) and docusate sodium (58 weight-% solids content) in water
Biocide (feed 9): Acticide MBS
Agitan® LF 305: Defoamer
Natrosol® 250HHR: Thickener
Disperbyk® 190: Dispersing agent
Acticide® MBS: Biocide
Formstar® ED 2523: Defoamer
Kronos® 2310: Pigment
AOAcell® HIDE 6299: Opacifier
Omyacarb® 5GU: Filler
Omyacarb® 2GU: Filler
Finntalc® M 15: Filler
Rheovis® PE 1320: Thickener
Tego® wet 260: Wetting agent

### Example 1 Preparation of an Aqueous Polymer Dispersion According to the Present Invention—M(1): w/Ureido Methacrylate (UMA)+Acetoacetoxyethyl Methacrylate (AAEMA)

### Precharge

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 135.50 | g | styrene |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10% by weight aqueous solution of ascorbic acid |

### Feed 9

| | |
|---|---|
| 2.62 g | 1.07 w % solution of biocide in water |
| 22.14 g | deionized water |

A polymerization vessel equipped with metering units and closed-loop temperature control was initially charged at 20 to 25° C. (room temperature) under a nitrogen atmosphere with the precharge and heated to 85° C. while stirring. On attainment of this temperature, 13.03% of feed 3 was metered in and stirred for 5 min. Then, while maintaining the temperature, simultaneously feed 1 and the remainder of feed 3 were started. Feed 1 was metered at constant feed rate into the reaction within 45 min and feed 3 was metered at constant feed rate into the reaction vessel within 150 min, while stirring was continued and the temperature of 85° C. was maintained. 45 min after the start of feed 1 feed 2 was fed into the reaction vessel within 105 min. After having metered feed 2 completely into the reaction vessel, feed 4 was added and stirring at 85° C. was continued for 30 min. After that feed 5 was dosed within 15 min. After that, feed 6 was added and stirring was continued at 85° C. for 20 min. Feed 7 was added and stirred in for 5 min. Then feed 8 was metered into the reaction vessel within 60 min at constant feed rate. After complete addition of feed 8 the dispersion was allowed to cool to room temperature before feed 9 was added and stirred in for 5 min.

### Example 2 Preparation of an Aqueous Polymer Dispersion According to the Present Invention—M(1): w/AAEMA w/o UMA

### Precharge

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 135.50 | g | styrene |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 250.00 | g | 2-ethylhexyl acrylate |
| 79.75 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10. % by weight aqueous solution of ascorbic acid |

### Feed 9

| | |
|---|---|
| 2.62 g | 1.07 w % solution of biocide in water |
| 22.14 g | deionized water |

The procedure for this example was the same as in Example 1, except that the above feeds have been used.

### Example 3 Preparation of an Aqueous Polymer Dispersion According to the Present Invention—M(1): w/UMA w/o AAEMA

### Precharge

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 135.50 | g | styrene |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 39.00 | g | ureido methacrylate (25% in Methyl methacrylate) |
| 250.00 | g | 2-ethylhexyl acrylate |
| 50.50 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10% by weight aqueous solution of ascorbic acid |

### Feed 9

| | |
|---|---|
| 2.62 g | 1.07 w % solution of biocide in water |
| 22.14 g | deionized water |

The procedure for this example was the same as in Example 1, except that the above feeds have been used.

### Reference Example 4 Preparation of an Aqueous Polymer Dispersion not According to the Present Invention—M(1): w/o UMA and AAEMA

### Precharge

| | |
|---|---|
| 231.13 g | deionized water |
| 30.30 g | seed latex (polystyrene, 30 nm, at 33% solids) |

### Feed 1: as in Example 1

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 250.00 | g | 2-ethylhexyl acrylate |
| 89.50 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10% by weight aqueous solution of ascorbic acid |

### Feed 9

| | |
|---|---|
| 2.62 g | 1.07 w % solution of biocide in water |
| 22.14 g | deionized water |

The procedure for this example was the same as in Example 1, except that the above feeds have been used.

### Example 5 Preparation of an Aqueous Polymer Dispersion According to the Present Invention—M(1): w/UMA+AAEMA

### Precharge

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | acrylic acid |
| 10.00 | g | 2-ethylhexyl acrylate |
| 135.50 | g | styrene |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | acrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10% by weight aqueous solution of ascorbic acid |

### Feed 9

| | |
|---|---|
| 2.62 g | 1.07 w % solution of biocide in water |
| 22.14 g | deionized water |

The procedure for this example was the same as in Example 1, except that the above feeds have been used.

### Example 6 Preparation of an Aqueous Polymer Dispersion According to the Present Invention—M(1): w/UMA+AAEMA and w/o Emulsifier Solution 2+M(2): w/o Emulsifier Solution 2

### Precharge

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 44.72 | g | deionized water |
| 13.87 | g | emulsifier solution 1 |
| 0.78 | g | emulsifier solution 3 |
| 4.50 | g | methacrylic acid |
| 10.00 | g | 2-ethylhexyl acrylate |
| 135.50 | g | styrene |

### Feed 2:

### Aqueous Mixture M(1) (Emulsion of)

| | | |
|---|---|---|
| 104.60 | g | deionized water |
| 32.26 | g | emulsifier solution 1 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10% by weight aqueous solution of ascorbic acid |

### Feed 9

| | |
|---|---|
| 2.62 g | 1.07 w % solution of biocide in water |
| 22.14 g | deionized water |

The procedure for this example was the same as in Example 1, except that the above feeds have been used.

### Example 7 Preparation of an Aqueous Polymer Dispersion According to the Present Invention—M(1): w/UMA+AAEMA

### Precharge

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 135.50 | g | methylmethacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3

| | |
|---|---|
| 14.29 g | sodium peroxodisulfate (7 w % in water) |

### Feed 4

| | |
|---|---|
| 12.20 g | deionized water |

### Feed 5

| | |
|---|---|
| 8.00 g | Ammonia (10%) |

### Feed 6

| | |
|---|---|
| 0.25 g | Agitan LF 305 |
| 1.35 g | deionized water |

### Feed 7

| | |
|---|---|
| 10.00 g | 10% by weight aqueous solution of tert-butyl hydroperoxide |
| 24.40 g | deionized water |

### Feed 8

| | |
|---|---|
| 6.00 g | 10% by weight aqueous solution of ascorbic acid |

### Feed 9

| | |
|---|---|
| 2.62 g | 1.07 w % solution of biocide in water |
| 22.14 g | deionized water |

The procedure for this example was the same as in Example 1, except that the above feeds have been used.

### Example 8 Preparation of an Aqueous Polymer Dispersion According to the Present Invention—M(1): w/UMA+AAEMA

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 35.50 | g | styrene |
| 100.00 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Example 9 Preparation of an Aqueous Polymer Dispersion According to the Present Invention—M(1): w/UMA+AAEMA

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 67.75 | g | styrene |
| 67.75 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Example 10 Preparation of an Aqueous Polymer Dispersion According to the Present Invention—M(1): w/UMA+AAEMA

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 100.00 | g | styrene |
| 35.50 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Example 11 Preparation of an Aqueous Polymer Dispersion According to the Present Invention—M(1): w/UMA w/o AAEMA

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 135.50 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 39.00 | g | ureido methacrylate (25% in Methyl methacrylate) |
| 250.00 | g | 2-ethylhexyl acrylate |
| 50.50 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Example 12 Preparation of an Aqueous Polymer Dispersion According to the Present Invention—M(1): w/o UMA w/AAEMA

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | methacrylic acid |
| 10.00 | g | 2-ethylhexyl acrylate |
| 135.50 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | methacrylic acid |
| 9.75 | g | acetoacetoxyethyl methacrylate |
| 250.00 | g | 2-ethylhexyl acrylate |
| 79.75 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Example 13 Preparation of an Aqueous Polymer Dispersion According to the Present Invention—M(1): w/UMA+AAEMA

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 5.25 | g | emulsifier solution 2 |
| 0.78 | g | emulsifier solution 3 |
| 4.50 | g | acrylic acid |
| 10.00 | g | 2-ethylhexyl acrylate |
| 135.50 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 12.00 | g | emulsifier solution 2 |
| 1.72 | g | emulsifier solution 3 |
| 10.50 | g | acrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Example 14 Preparation of an Aqueous Polymer Dispersion According to the Present Invention—M(1): w/UMA+AAEMA and w/o Emulsifier Solution

### Precharge:

| | |
|---|---|
| 231.13 g | deionized water |
| 30.30 g | seed latex (polystyrene, 30 nm, at 33% solids) |

### Feed 1:

### Aqueous Mixture M(2) (Emulsion of)

| | | |
|---|---|---|
| 41.56 | g | deionized water |
| 13.87 | g | emulsifier solution 1 |
| 0.78 | g | emulsifier solution 3 |
| 4.50 | g | methacrylic acid |
| 10.00 | g | 2-ethylhexyl acrylate |
| 135.50 | g | methyl methacrylate |

### Feed 2:

### Aqueous Mixture M(1) (Emulsion of)

| | | |
|---|---|---|
| 97.38 | g | deionized water |
| 32.26 | g | emulsifier solution 1 |
| 1.72 | g | emulsifier solution 3 |
| 10.50 | g | methacrylic acid |
| 9.75 | g | acetoacetoxyethyl methacrylate |
| 39.00 | g | ureido methacrylate (25% in Methyl methacrylate) |
| 250.00 | g | 2-ethylhexyl acrylate |
| 40.75 | g | methyl methacrylate |

### Feed 3:

| | |
|---|---|
| 14.29 g | sodium peroxodisulfate (7 w % in water) |

### Feed 4:

| | |
|---|---|
| 12.20 g | deionized water |

### Feed 5:

| | |
|---|---|
| 8.00 g | Ammonia (10%) |

### Feed 6:

| | |
|---|---|
| 0.25 g | Agitan LF 305 |
| 1.35 g | deionized water |

### Feed 7:

| | |
|---|---|
| 10.00 g | 10% by weight aqueous solution of tert-butyl hydroperoxide |
| 24.40 g | deionized water |

### Feed 8:

| | |
|---|---|
| 6.00 g | 10% by weight aqueous solution of ascorbic acid |

### Feed 9:

| | |
|---|---|
| 2.62 g | 1.07 w % solution of biocide in water |
| 22.14 g | deionized water |

The procedure for this example was the same as in Example 1, except that the above feeds have been used.

### Comparative Example 1 Dispersion not According to the Present Invention (with Good Scrub but Bad Blocking Res. And Bad Wet Adhesion)

### Precharge:

| | |
|---|---|
| 192.62 g | deionized water |
| 6.89 g | seed latex (polystyrene, 30 nm, at 33% solids) |

### Feed 1:

### Aqueous Mixture M(1) (Emulsion of)

| | | |
|---|---|---|
| 282.13 | g | deionized water |
| 29.68 | g | emulsifier solution 1 |
| 8.45 | g | acrylic acid |
| 19.50 | g | acrylamide |
| 394.00 | g | n-butyl acrylate |
| 267.80 | g | methyl methacrylate |

### Feed 2:

| | |
|---|---|
| 11.16 g | sodium peroxodisulfate (7 w % in water) |

### Feed 3:

| | |
|---|---|
| 13.07 g | deionized water |

### Feed 4:

| | |
|---|---|
| 2.62 g | ammonia (25%) |

### Feed 5:

| | |
|---|---|
| 3.92 g | 10% by weight aqueous solution of tert-butyl hydroperoxide |

### Feed 6:

| | |
|---|---|
| 4.94 g | 13.1% by weight solution of acetonbisulfit |

### Feed 7:

| | |
|---|---|
| 48.28 g | deionized water |

### Feed 8:

| | |
|---|---|
| 2.62 g | 1.07 w % solution of biocide in water |
| 8.59 g | sodium hydroxide (10 w % in water) |

A polymerization vessel equipped with metering units and closed-loop temperature control was initially charged at 20 to 25° C. (room temperature) under a nitrogen atmosphere with precharge and heated to 95° C. while stirring. On attainment of this temperature, 10% of feed 2 was metered in and stirred for 5 min. Then, while maintaining the temperature, simultaneously feed 1 and the remainder of feed 2 were started. Feed 1 and 2 were both metered at a constant feed rate into the reaction within 165 min, while stirring was continued and the temperature of 95° C. was maintained. After having metered both feeds completely into the reaction vessel, feed 3 was added and stirring at 95° C. was continued for 15 min. After that, feed 4 was added and stirring was continued at 95° C. for 5 min. Then feed 5 and 6 were metered into the reaction vessel within 60 min at constant feed rate. After complete addition of feeds 5 and 6 stirring at 95° C. was continued for 15 min. Feed 7 was then added and the dispersion was allowed to cool to room temperature before feed 8 was added and stirred in for 5 min.

TABLE 1
Aqueous polymer dispersion properties

| | | | Coagulum | Solids | | | |
|---|---|---|---|---|---|---|---|
| | Tg (2) | Tg (1) | (% by | content | | Viscosity | HDC |
| Samples | (° C.) | (° C.) | weight) | (%) | pH | (mPas) | (nm) |
| Example 1 | 89.8 | −29.3 | 0.1 | 49.3 | 7.6 | 360 | 111 |
| Example 2 | 89.9 | −27.6 | 0.1 | 48.8 | 7.3 | 444 | 111 |
| Example 3 | 89.9 | −27.3 | 0.1 | 48.7 | 7.6 | 420 | 108 |
| Ref. | 89.9 | −25.7 | 0.1 | 49.2 | 7.6 | 736 | 107 |
| Example 4 | | | | | | | |
| Example 5 | 89.1 | −29.6 | 0.1 | 49 | 5.8 | 812 | 111 |
| Example 6 | 89.8 | −29.3 | 0.1 | 48.5 | 7.5 | 444 | 112 |
| Example 7 | 99.7 | −29.3 | 0.1 | 48.7 | 7.1 | 908 | 95 |
| Example 8 | 97.0 | −29.3 | 0.2 | 48.9 | 6.9 | 234 | 106 |
| Example 9 | 94.7 | −29.3 | 0.3 | 48.5 | 7.0 | 340 | 105 |
| Example 10 | 92.3 | −29.3 | 0.2 | 50.2 | 7.0 | 582 | 107 |
| Example 11 | 99.7 | −27.3 | 0.4 | 48.9 | 6.7 | 725 | 87 |
| Example 12 | 99.7 | −27.6 | 0.5 | 49.1 | 7.2 | 655 | 85 |
| Example 13 | 98.9 | −29.6 | 0.3 | 48 | 6.0 | 382 | 91 |
| Example 14 | 99.7 | −29.3 | 0.4 | 49.6 | 7.2 | 985 | 84 |
| Comp. | n.a. | 8.8 | 0.2 | 51.4 | 8.4 | 236 | 187 |
| Example 1 | | | | | | | |

### Example 15 Paint Formulations—Properties Testing

### 15.1 Preparing the Paint Formulations

Fifteen paint formulations were prepared as detailed below and in Table 2.

The paints were prepared by mixing water with the 10% sodium hydroxide solution. Further, Natrosol was added slowly while stirring (avoid lump formation), the mixture was left to soak at least overnight. Further, Disperbyk 190, Acticide MBS, Formstar ED 2523, Kronos 2310, Omyacarb 5GU, Omyacarb 2GU, Finntalc M 15 and Rheovis PE 1320 were added separately one after the other and mixed at 400 to 800 rpm. Further, the mixture was stirred with the Dispermat at 1000 rpm for 10 minutes. The temperature of the mixture should be of approx. 30° C. The mixture was left standing overnight. The binder (Ex.1-3 and 5-14, R.Ex.4 and C.Ex.1) and AQAcell HIDE 6299, were respectively added and stirred with a speed mixer. Finally, Tego wet 260, Foamstar ED 2523 and water were added and stirred with the speed mixer to obtain 15 paints as described in Table 2. The values in Table 2 are given in parts per thousand (by weight) unless otherwise indicated. The total solid content is given as weight percent calculated on the basis of all components present and indicated in the table as S.C.

TABLE 2

| | Paint | E1 | E2 | E3 | RE4 | E5 | E6 | E7 | E8 | E9 | E10 | E11 | E12 | E13 | E14 | CE1 |
|---|---|---|---|---|---|---|---|---|---|---|---|---|---|---|---|---|
| Ingredients | S.C. | | | | | | | | | | | | | | | |
| Water | | 86.0 | 86.0 | 86.0 | 86.0 | 86.0 | 86.0 | 86.0 | 86.0 | 86.0 | 86.0 | 86.0 | 86.0 | 86.0 | 86.0 | 86.0 |
| 10% NaOH sol. | | 8.0 | 8.0 | 8.0 | 8.0 | 8.0 | 8.0 | 8.0 | 8.0 | 8.0 | 8.0 | 8.0 | 8.0 | 8.0 | 8.0 | 8.0 |
| Natrossol 250 HHr | | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 |
| Disperbyk 190 | | 10.3 | 10.3 | 10.3 | 10.3 | 10.3 | 10.3 | 10.3 | 10.3 | 10.3 | 10.3 | 10.3 | 10.3 | 10.3 | 10.3 | 10.3 |
| Acticide MBS | | 0.0 | 0.0 | 0.0 | 0.0 | 0.0 | 0.0 | 0.0 | 0.0 | 0.0 | 0.0 | 0.0 | 0.0 | 0.0 | 0.0 | 0.0 |
| Foamstar ED 2523 | | 2.0 | 2.0 | 2.0 | 2.0 | 2.0 | 2.0 | 2.0 | 2.0 | 2.0 | 2.0 | 2.0 | 2.0 | 2.0 | 2.0 | 2.0 |
| Kronos 2310 | | 221.6 | 221.6 | 221.6 | 221.6 | 221.6 | 221.6 | 221.6 | 221.6 | 221.6 | 221.6 | 221.6 | 221.6 | 221.6 | 221.6 | 221.6 |
| AQACell HIDE 6299 | | 50.6 | 50.6 | 50.6 | 50.6 | 50.6 | 50.6 | 50.6 | 50.6 | 50.6 | 50.6 | 50.6 | 50.6 | 50.6 | 50.6 | 50.6 |
| Omyacarb 5GU | | 23.7 | 23.7 | 23.7 | 23.7 | 23.7 | 23.7 | 23.7 | 23.7 | 23.7 | 23.7 | 23.7 | 23.7 | 23.7 | 23.7 | 23.7 |
| Omyacarb 2GU | | 39.6 | 39.6 | 39.6 | 39.6 | 39.6 | 39.6 | 39.6 | 39.6 | 39.6 | 39.6 | 39.6 | 39.6 | 39.6 | 39.6 | 39.6 |
| Finntalc M 15 | | 39.5 | 39.5 | 39.5 | 39.5 | 39.5 | 39.5 | 39.5 | 39.5 | 39.5 | 39.5 | 39.5 | 39.5 | 39.5 | 39.5 | 39.5 |
| Rheovis PE 1320 | | 8.0 | 8.0 | 8.0 | 8.0 | 8.0 | 8.0 | 8.0 | 8.0 | 8.0 | 8.0 | 8.0 | 8.0 | 8.0 | 8.0 | 8.0 |
| Binder Ex. 1 | | 460.6 | 0 | 0 | 0 | 0 | 0 | 0 | 0 | 0 | 0 | 0 | 0 | 0 | 0 | 0 |
| Binder Ex. 2 | | 0 | 465.4 | 0 | 0 | 0 | 0 | 0 | 0 | 0 | 0 | 0 | 0 | 0 | 0 | 0 |
| Binder Ex. 3 | | 0 | 0 | 466.3 | 0 | 0 | 0 | 0 | 0 | 0 | 0 | 0 | 0 | 0 | 0 | 0 |
| Binder Ex. 4 | | 0 | 0 | 0 | 461.6 | 0 | 0 | 0 | 0 | 0 | 0 | 0 | 0 | 0 | 0 | 0 |
| Binder Ex. 5 | | 0 | 0 | 0 | 0 | 463.5 | 0 | 0 | 0 | 0 | 0 | 0 | 0 | 0 | 0 | 0 |
| Binder Ex. 6 | | 0 | 0 | 0 | 0 | 0 | 468.2 | 0 | 0 | 0 | 0 | 0 | 0 | 0 | 0 | 0 |
| Binder Ex. 7 | | 0 | 0 | 0 | 0 | 0 | 0 | 466.3 | 0 | 0 | 0 | 0 | 0 | 0 | 0 | 0 |
| Binder Ex. 8 | | 0 | 0 | 0 | 0 | 0 | 0 | 0 | 460.9 | 0 | 0 | 0 | 0 | 0 | 0 | 0 |
| Binder Ex. 9 | | 0 | 0 | 0 | 0 | 0 | 0 | 0 | 0 | 464.7 | 0 | 0 | 0 | 0 | 0 | 0 |
| Binder Ex. 10 | | 0 | 0 | 0 | 0 | 0 | 0 | 0 | 0 | 0 | 449.0 | 0 | 0 | 0 | 0 | 0 |
| Binder Ex. 11 | | 0 | 0 | 0 | 0 | 0 | 0 | 0 | 0 | 0 | 0 | 460.9 | 0 | 0 | 0 | 0 |
| Binder Ex. 12 | | 0 | 0 | 0 | 0 | 0 | 0 | 0 | 0 | 0 | 0 | 0 | 459.1 | 0 | 0 | 0 |
| Binder Ex. 13 | | 0 | 0 | 0 | 0 | 0 | 0 | 0 | 0 | 0 | 0 | 0 | 0 | 469.6 | 0 | 0 |
| Binder Ex. 14 | | 0 | 0 | 0 | 0 | 0 | 0 | 0 | 0 | 0 | 0 | 0 | 0 | 0 | 454.4 | 0 |
| Binder C.Ex. 1 | | 0 | 0 | 0 | 0 | 0 | 0 | 0 | 0 | 0 | 0 | 0 | 0 | 0 | 0 | 446.7 |
| Tego wet 260 | | 2 | 2 | 2 | 2 | 2 | 2 | 2 | 2 | 2 | 2 | 2 | 2 | 2 | 2 | 2 |
| Foamstar ED 2523 | | 2 | 2 | 2 | 2 | 2 | 2 | 2 | 2 | 2 | 2 | 2 | 2 | 2 | 2 | 2 |
| Water | | 45.1 | 40.3 | 39.4 | 44.1 | 42.2 | 37.5 | 39.4 | 44.8 | 41.0 | 56.7 | 44.8 | 46.6 | 36.1 | 51.3 | 59.0 |
| Total | | 1000 | 1000 | 1000 | 1000 | 1000 | 1000 | 1000 | 1000 | 1000 | 1000 | 1000 | 1000 | 1000 | 1000 | 1000 |
| PVC (Paint) [%] | | 32.1 | 32.1 | 32.1 | 32.1 | 32.1 | 32.1 | 32.1 | 32.1 | 32.1 | 32.1 | 32.1 | 32.1 | 32.1 | 32.1 | 32.1 |
| S.C. (Paint) [wt %] | | 56.5 | 56.5 | 56.5 | 56.5 | 56.5 | 56.5 | 56.4 | 56.5 | 56.5 | 56.5 | 56.5 | 56.5 | 56.5 | 56.5 | 55.4 |

### 15.2 Testing

Wet adhesion, wet scrub resistance, opacity, block resistance were measured for the obtained paints. The results are shown in Table 3 below.

| | Paint E1 | Paint E2 | Paint E3 | Paint RE4 | Paint E5 | Paint E6 | Paint E7 | |
|---|---|---|---|---|---|---|---|---|
| Parameter/Sample | binder Ex. 1 | binder Ex.2 | binder Ex.3 | binder Ref Ex.4 | binder Ex.5 | binder Ex.6 | binder Ex.7 | |
| Wet Scrub [μm] | 3 | 2 | 3 | 2 | 5 | 3 | 4 | |
| Blocking resistance force | 2 | 2.5 | 2.5 | 1.5 | 1.5 | 1 | 1 | |
| Blocking resistance Failure | 2 | 2 | 4 | 2 | 2 | 2 | 2 | |
| Spreading rate at 98% CR | 8.5 | 8.8 | 9.4 | 8.6 | 9.2 | 8.1 | 8.6 | |
| [m²/L] | | | | | | | | |
| Spreading rate at 99.5% CR | 5.1 | 5.1 | 4.4 | 5.4 | 5.5 | 5.0 | 4.9 | |
| [m²/L] | | | | | | | | |
| Gloss at 85° | 46.8 | 44.3 | 47.2 | 43.4 | 47.1 | 46.0 | 42.4 | |
| Wet adhesion (0 best. 5 worst) | 1.5 | 1 | 1.5 | 5 | 1.5 | 1 | 1 | |
| | Paint E8 | Paint E9 | Paint E10 | Paint E11 | Paint E12 | Paint E13 | Paint E14 | Paint CE1 |
| Parameter/Sample | binder Ex.8 | binder Ex.9 | binder Ex. 10 | binder Ex.11 | binder Ex.12 | binder Ex. 13 | binder Ex. 14 | binder Co.Ex. 1 |
| Wet Scrub [μm] | 3 | 3 | 3 | 4 | 3 | 4 | 3 | 3 |
| Blocking resistance force | 1.5 | 2 | 1.5 | 2 | 2 | 1 | 1 | 3 |
| Blocking resistance Failure | 2 | 2 | 2 | 2 | 2 | 2 | 2 | 4 |
| Spreading rate at 98% CR | 8.8 | 9.3 | 8.7 | 9.4 | 9.4 | 10.5 | 9.5 | 9.1 |
| [m²/L] | | | | | | | | |
| Spreading rate at 99.5% CR | 5.0 | 4.8 | 4.9 | 4.9 | 5.4 | 5.6 | 5.2 | 5.4 |
| [m²/L] | | | | | | | | |
| Gloss at 85° | 47.5 | 46.0 | 46.9 | 42.1 | 40.8 | 46.3 | 41.9 | 41.7 |
| Wet adhesion (0 best. 5 worst) | 1 | 1 | 1 | 1 | 1.5 | 1 | 1 | 5 |

As may be taken from Table 3, it is clear that the combination of good wet adhesion, good wet scrub and good blocking resistance is only achieved with the paints using the aqueous polymer dispersions according to the present invention/prepared according to the process of the present invention.

### CITED LITERATURE

EP 0710680 A2
EP 2840092 A1
T. G. Fox, Bulletin of the American Physical Society 1, page 123 (1956 [Ser. II])
Ullmann's Encyclopedia of Industrial Chemistry (vol. 19, page 18, 4^{th} Edition, Verlag Chemie, Weinheim, 1980)
Ullmann's Encyclopedia of Industrial Chemistry (vol. A21, page 169, 5^{th} Edition, Verlag Chemie, Weinheim, 1992)
J. Brandrup, E. H. Immergut, Polymer Handbook, 1^{st} Edition—J. Wiley, New York 1966, 2^{nd} Edition—J. Wiley, New York 1975, and 3^{rd} Edition—J. Wiley, New York 1989

1.-24. (canceled)

25. A process for preparing an aqueous polymer dispersion D(P), the process comprising
(i) providing a first aqueous mixture M(1) comprising water and ethylenically unsaturated monomers, wherein at least x weight-% of said ethylenically unsaturated monomers consist of one or more monomers according to formula (I) 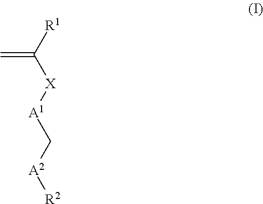
wherein R¹ is H or CH₃, X is CO or CH₂, A¹ is O or NH, A² is selected from the group consisting of CH₂, C(CH₃)₂ and CH(OH) and R² is selected from the group consisting of an ester group, an amido group, a urea group, an alkylamine group, a carbonyl group, an alkyl group and an alkoxy group, wherein from 95 to 100 weight-% of M(1) consist of water and said ethylenically unsaturated monomers;
(ii) providing a second aqueous mixture M(2) comprising water and at least two different ethylenically unsaturated monomers, wherein from 55 to 98 weight-% of said unsaturated monomers consist of one or more of vinyl aromatic monomers, C₁-C₂₀-alkyl esters of methacrylic acid and C₁-C₂₀-alkyl esters of acrylic acid, and wherein y weight-% of said ethylenically unsaturated monomers consist of the one or more monomers according to formula (I) with 0≤y<x, and wherein from 95 to 100 weight-% of M(2) consist of water and said at least two different ethylenically unsaturated monomers;
(iii) introducing M(2) into a polymerization vessel and subjecting the ethylenically unsaturated monomers comprised in M(2) to co-polymerization for a first polymerization period Δt(1), obtaining an intermediate mixture M(i);
(iv) introducing, after Δt(1), M(1) into the polymerization vessel comprising M(i), admixing M(1) and M(i) obtaining a polymerization mixture M(P), and subjecting the ethylenically unsaturated monomers to co-polymerization, obtaining, after a second polymerization period Δt(2), the aqueous polymer dispersion D(P), wherein at least 95 weight-% of the polymers comprised in D(P) after Δt(2) are based on the ethylenically unsaturated monomers comprised in M(1) and M(2).

26. The process of claim 25, wherein Tg(2)>Tg(1), Tg(2) being the theoretical glass transition temperature (Tg) of the polymer which would be obtained from polymerization of the monomers of the mixture M(2) and Tg(1) being the theoretical glass transition temperature (Tg) of the polymer which would be obtained from polymerization of the monomers of the mixture M(1), wherein said theoretical glass transition temperatures Tg(1) and Tg(2) are determined according to the Fox equation

27. The process of claim 25, wherein Tg(2)>30° C., Tg(2) being the theoretical glass transition temperature (Tg) of the polymer which would be obtained from polymerization of the monomers of the mixture M(2);
wherein Tg(1)<−5° C., Tg(1) being the theoretical glass transition temperature (Tg) of the polymer which would be obtained from polymerization of the monomers of the mixture M(1).

28. The process of claim 25, wherein, in formula (I), R² is selected from the group consisting of an ester group, an amido group, a urea group and a dialkylamine group.

29. The process of claim 28, wherein, in formula (I), R² is an ester group, R¹ is CH₃, X is CO, A¹ is O and A² is CH₂, the monomer of formula (I), comprised in the first aqueous mixture M(1); or
wherein, in formula (I), R² is a urea group, R¹ is CH₃, X is CO, A¹ is O and A² is CH₂.

30. The process of claim 25, wherein the monomers according to formula (I), comprised in the first aqueous mixture M(1), are at least two different monomers of formula (I), the at least two monomers being
a monomer, wherein R¹ is CH₃, X is CO, A¹ is O, A² is CH₂ and R² is an ester group, and
a monomer, wherein R¹ is CH₃, X is CO, A¹ is O, A² is CH₂ and R² is a urea group;
wherein preferably the monomers of formula (I) are acetoacetoxyethyl methacrylate and ureido methacrylate; or
wherein the monomers according to formula (I), comprised in the first aqueous mixture M(1), are the same monomers, wherein R¹ is CH₃, X is CO, A¹ is O, A² is CH₂ and R² is an ester group or wherein R¹ is CH₃, R¹ is CH₃, X is CO, A¹ is O, A² is CH₂ and R² is a urea group;
wherein the monomer according to formula (I) is ureido methacrylate or acetoacetoxyethyl methacrylate.

31. The process of claim 25, wherein x is in the range of from 0.25 to 15.

32. The process of claim 25, wherein the ethylenically unsaturated monomers comprised in the first aqueous mixture M(1) further comprises monomers which exhibit a Bronsted acidic group, wherein the monomers which exhibit a Bronsted acidic group are selected from the group consisting of monoethylenically unsaturated monocarboxylic acids having 3 to 6 carbon atoms, monoethylenically unsaturated dicarboxylic acids having 4 to 6 carbon atoms and a mixture thereof, more preferably monoethylenically unsaturated monocarboxylic acids having 3 to 6 carbon atoms;
wherein from 0.5 to 5 weight-% of the ethylenically unsaturated monomers comprised in the first aqueous mixture M(1) consist of the monomers which exhibit a Bronsted acidic group.

33. The process of claim 32, wherein, in the first aqueous mixture M(1), the ratio of the masses of the monomers which exhibit a Bronsted acidic group, m₁(a), to the one or more monomers of formula (I), m₁(monomers), m₁(a):m₁(monomers), is in the range of from 0.25:1 to 3:1.

34. The process of claim 25, wherein the ethylenically unsaturated monomers comprised in the first aqueous mixture M(1) further comprises one or more of C₁-C₂₀-alkyl esters of acrylic acid and C₁-C₂₀-alkylesters of methacrylic acid.

35. The process of claim 34, wherein the C₁-C₂₀-alkyl esters of acrylic acid is selected from the group consisting of methyl acrylate, ethyl acrylate, n-propyl acrylate, isopropyl-acrylate, n-butyl acrylate, 2-butyl acrylate, isobutyl acrylate, n-pentyl acrylate, isoamyl acrylate, n-hexyl acrylate, n-octyl acrylate, 2-octyl acrylate, 2-ethylhexylacrylate, n-decyl acrylate, 2-propylheptyl acrylate, lauryl acrylate, C₁₂-C₁₄-alkyl acrylate, stearyl acrylate, isobornyl acrylate, and a mixture of two or more thereof.

36. The process of claim 25, wherein the first aqueous mixture M(1) is an emulsion and the second aqueous mixture M(2) is an emulsion.

37. The process of claim 25, wherein from 65 to 95 weight-% of the ethylenically unsaturated monomers comprised in the second aqueous mixture M(2) consist of one or more of vinyl aromatic monomers, C₁-C₂₀-alkyl esters of methacrylic acid, and C₁-C₂₀-alkyl esters of acrylic acid, preferably one or more of styrene, methyl methacrylate, ethyl acrylate, n-propyl acrylate, isopropyl-acrylate, n-butyl acrylate, 2-butyl acrylate, isobutyl acrylate, t-butyl methacrylate, t-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C12/C14-alkyl acrylate, stearyl acrylate, cyclohexylmethacrylate, isobornyl acrylate, isobornyl methacrylate, 2-methylstyrene, 4-methylstyrene, 2-n-butylstyrene, 4-n-butylstyrene, α-methylstyrene and vinyl acetate.

38. The process of claim 37, wherein from 65 to 95 weight-% of the ethylenically unsaturated monomers comprised in the second aqueous mixture M(2) consist of one or more of styrene, methyl methacrylate, ethyl methacrylate, t-butyl methacrylate, t-butyl acrylate, cyclohexylmethacrylate, benzyl methacrylate, isobornyl acrylate, isobornyl methacrylate, and vinyl acetate; preferably one or more of styrene, methyl methacrylate, t-butyl methacrylate, t-butyl acrylate, cyclohexylmethacrylate and vinyl acetate.

39. The process of claim 25, wherein the ethylenically unsaturated monomers comprised in the second aqueous mixture M(2) comprise styrene and methyl methacrylate;
wherein the weight ratio of styrene to methyl methacrylate in the second aqueous mixture M(2) is in the range of from 0.2:1 to 4:1 of the ethylenically unsaturated monomers comprised in the second aqueous mixture M(2) consist of styrene and methyl methacrylate.

40. The process of claim 25, wherein the ethylenically unsaturated monomers comprised in the second aqueous mixture M(2) further comprises monomers which exhibit a Bronsted acidic group comprised in M(2), said monomers are selected from the group consisting of monoethylenically unsaturated monocarboxylic acids having 3 to 6 carbon atoms, monoethylenically unsaturated dicarboxylic acids having 4 to 6 carbon atoms, and mixture of two or more thereof,
wherein preferably from 1.0 to 10 weight-% of the ethylenically unsaturated monomers comprised in the second aqueous mixture M(2) consist of monomers which exhibit a Bronsted acidic group.

41. The process of claim 25, wherein the ethylenically unsaturated monomers comprised in the second aqueous mixture M(2) further comprises C₁-C₂₀-alkyl esters of acrylic acid, wherein the C₁-C₂₀-alkyl ester of acrylic acid is preferably selected from the group consisting of methyl acrylate, ethyl acrylate, n-propyl acrylate, isopropyl-acrylate, n-butyl acrylate, acrylate, 2-butyl acrylate, isobutyl acrylate, n-pentyl acrylate, iso-amyl acrylate, n-hexyl acrylate, n-octyl acrylate, 2-octyl acrylate, 2-ethylhexylacrylate, n-decyl acrylate, 2-propylheptyl acrylate, lauryl acrylate, C12/C14-alkyl acrylate, stearyl acrylate, isobornyl acrylate, and a mixture of two or more thereof;
wherein the ethylenically unsaturated monomers comprised in the second aqueous mixture M(2) preferably further comprises C₂-C₁₀ alkyl esters of acrylic acid, wherein the ester of acrylic acid is more preferably selected from the group consisting of n-butyl acrylate, iso-butyl acrylate, iso-amyl acrylate, n-hexyl acrylate, n-octyl acrylate, 2-octyl acrylate, 2-ethylhexyl acrylate, 2-propylheptyl acrylate, isobornyl acrylate, and a mixture of two or more thereof, more preferably selected from the group consisting of n-butyl acrylate, iso-butyl acrylate, iso-amyl acrylate, 2-octyl acrylate, 2-ethylhexyl acrylate and a mixture of two or more thereof, more preferably selected from the group consisting of n-butyl acrylate, 2-ethylhexyl acrylate and a mixture thereof, more preferably is 2-ethylhexyl acrylate;
wherein preferably from 3.5 to 25 weight-% of the ethylenically unsaturated monomers comprised in the second aqueous mixture M(2) consist of C₁-C₂₀-alkyl esters of acrylic acid, preferably C₂-C₁₀ alkyl esters of acrylic acid.

42. The process of claim 25, wherein 0≤y<0.5.

43. The process of claim 25, wherein the second aqueous mixture M(2) further comprises one or more surfactants, wherein the surfactants are each selected from the group consisting of an anionic surfactant, a non-ionic surfactant and a mixture thereof,
wherein the second aqueous mixture M(2) comprises at least two surfactants, which are chemically and physically different from one other, more preferably the second aqueous mixture M(2) comprises an anionic surfactant comprising a phosphate group and an anionic surfactant comprising a sulfate group.

44. The process of claim 25, wherein the first polymerization period Δt(1)<the second polymerization period Δt(2);
wherein Δt(2): Δt(1) is in the range of from 1:1 to 5:1.

45. An aqueous polymer dispersion obtained by a process according to claim 25, having a polymer content in the range of from 40 to 70 weight-%, based on the total weight of the aqueous polymer dispersion.

46. The aqueous polymer dispersion of claim 45, having a monomodal particle size distribution, wherein the particles of the dispersion have an average diameter in the range of from 10 to 400 nm.

47. Use of an aqueous polymer dispersion according to claim 45 as binder for coatings, preferably decorative coatings.

48. A coating comprising an aqueous polymer dispersion according to claim 45 in an amount in the range of from 5 to 50 weight-% and a pigment.
